(19) United States
(12) Patent Application Publication
(10) Pub. No.: US 2005/0097440 A1
(43) Pub. Date: May 5, 2005

(54) Method and system for collaboration

(76) Inventors: Richard Lusk, Bonsall, CA (US); Jean-Pierre Etsuo Poveda, Torrance, CA (US); Daniel Peter O'Shea, Newport Beach, CA (US)

Correspondence Address: Don Camegie, Suite 5A #540, 5405 Alton Pkwy, Irvine, CA, 92604, US

(21) Appl. No.: 10/980,763

(22) Filed: Nov. 3, 2004

Related U.S. Application Data
(60) Provisional application No. 60/517,271, filed on Nov. 4, 2003.

(51) Int. Cl. G06F 15/00

(52) U.S. Cl. 715/500.1

(57) ABSTRACT

A scalable and reliable collaborative software application that provides an information hub that serves as a single portal to using applications in an aggregated, collaborative manner, thereby eliminating the need for constant transmission/reception of information to achieve collaboration, is presented. The present invention creates a portal for all entities, and enables access, storage, sharing, and response to related information from anywhere at anytime on any access unit in a collaborative and collective methodology. The present invention also provides object-based security and object-based threaded discussion sessions for all objects generated by the various applications.

### CROSS-REFERENCE TO RELATED APPLICATIONS

The present application claims priority from related U.S. Provisional Application Ser. No. 60/517,271, filed Nov. 4, 2003, the entire disclosure of which is incorporated herein by reference.

### BACKGROUND OF THE INVENTION

(1) Field of the Invention

This invention relates to the aggregation of relevant information in a single centralized zone, and more specifically, integration of such information that is normally extended across multiple applications and platforms.

(2) Description of Related Art

Most of today's collaboration software are intimately linked to one form of communication software or another, in particular electronic mail (Email), the inherent limitations of which limit collaboration. To collaborate means to work together, especially in a joint intellectual effort, which requires a very close interaction amongst entities (disparate software applications, platforms, and or one or more users) and a common space where information is readily shared. These are requirements that, as of today, have not been met by prior art collaboration software applications, an example of which is the published United States Patent Application 2003/0135565 to Estrada, the entire disclosure of which is incorporated herein by reference.

Estrada provides Email-centric solutions to problems associated with electronic collaboration amongst disparate entities. The system taught by Estrada may be construed as a collaboration extraction layer that extends third party Email products by adding collaborative functionality on top of the Email applications. To overcome inherent limitations with collaboration software that are dependent on Email, the collaborative functionality must allow for synchronization of information across entities. In other words, Estrada adds a collaboration layer on top of standard Email applications, which allows for synchronization of such disparate Email applications and users in an abstract manner, hiding all the details of synchronization from end user.

As further taught by Estrada, the initialization process for new participants joining a project (the synchronization of the new user work space with those already participating, e.g., forwarding of copies of files and applications to the new user project space) may become burdensome if the number of files and applications to be synchronized is large. Synchronization, whether for a large or small content, is one of many important, inherent limitations of Email-centric collaboration software applications. Any effort that alters the contents of a workspace for one user must be replicated in all other authorized user workspaces so that all authorized user workspaces are synchronized for collaboration. This requires a constant forwarding of massive amounts of information between participants on a regular basis, making synchronization amongst users a very burdensome process, which has been acknowledged by Estrada, especially for initialization of new participants.

Email-centric collaboration software applications also suffer when extremely large files are communicated amongst collaborators. In general, it would be impractical to propagate large files via Email to every single participant in the collaboration and even more impractical for every single participant to download those files every time one is received. This is due to the fact that communication of large files via Email is slow, and the downloading of those files even slower. One reason for the slow communication and downloading of large files is that Email applications fully dependent on the underlying communication link (the network of computers, the Internet, etc.) to transmit/receive information, and if the underlying link is slow, so will the Email. Therefore, as with all other inherent limitations of Email, the Email-centric collaboration software applications also inherit this inherent limitation as well, making the use of Email as a main tool for collaboration a poor choice.

Another major flaw with Email-centric collaboration software applications is the possibility for the failure of the Email system itself with which the Email-centric collaboration layer is so intimately associated. No collaboration exists if the Email application fails. When the Email application is restored, collaboration may continue after all the workspaces of all the participants are synchronized. In order to avoid failure and be able to communicate, all users of such systems are constantly faced with continually increasing cost of deployment, maintenance, and management of separate Email applications, and Email-centric collaboration software systems. The resulting annual operational expenditures to maintain and manage these systems waste valuable resources.

In light of the current state of the art and the drawbacks to current systems mentioned above, and the explosive growth of the Internet, horizontal and vertical software applications, and the ever growing need for collaboration amongst entities, a need exists for a system and a method that would enable collaboration amongst entities with small cost for deployment and use, and no cost for maintenance and management to end users, and that would further not intimately be linked to Email or any standard protocol that requires constant transmission/reception of information to achieve collaboration.

### BRIEF SUMMARY OF THE INVENTION

The present invention provides an information hub that serves as a single portal to using applications in an aggregated, collaborative manner, thereby eliminating the need for synchronization through constant transmission/reception of information to achieve collaboration. It creates a portal for all entities, and enables access, storage, sharing, and response to related information from anywhere at anytime on any network enabled or Internet device via any access unit in a collaborative and aggregated methodology.

One aspect of the present invention provides a system and a method for collaboration, comprising the acts of:
providing a computer-implemented system that creates a single portal for entity members of the computer-implemented system to a set of software application tools, and that serves as a hub for collaboration amongst the entity members of the computer-implemented system;
the set of software application tools generating computer-implemented system objects, with the computer-implemented system objects providing:
   a centralized space for a project that provides a work zone for maintaining information related to the project within the work zone;
   an assembling of a distributed workgroup comprised of at least one entity member of the computer-implemented system into the work zone, thereby making the entity member of the computer-implemented system a work zone member, which unifies the work zone member and the project into the work zone to enable the work zone member and the entity member of the computer-implemented system to collaborate.

Another aspect of the present invention provides a system and a method for collaboration, wherein the work zone is a project specific environment that enables authorized access to the set of software application tools, and allows the set of software application tools to function collectively and collaboratively, specific to the project.

Yet another aspect of the present invention provides a system and a method for collaboration, wherein each work zone for each of the projects has a complete set of software application tools.

Still another aspect of the present invention provides a system and a method for collaboration, wherein the computer-implemented system sorts, organizes, and saves new and altered information of the work zone to the work zone.

A further aspect of the present invention is a system and a method for collaboration, wherein the set of software application tools is comprised of front-end module applications and back-end core applications.

Still a further aspect of the present invention is a system and a method for collaboration, wherein the front-end module applications and the back-end core applications are comprised of work zone aware vertical and horizontal software applications.

Yet a further aspect of the present invention is a system and a method for collaboration, wherein the front-end module applications are comprised of:
a thin client layer for accessing the computer-implemented system through an access units;
a presentation layer for abstracting data for the client layer; and
a controller layer that provides reusable business logic that drives the presentation layer.

Another aspect of the present invention provides a system and a method for collaboration, wherein the front-end module applications reside in the work zone, and are comprised of at least one of a discussion, summary, document, calendar, task, contact, instant messaging, and email module software application.

Yet another aspect of the present invention provides a system and a method for collaboration, wherein the work zone is comprised of a set of graphic user interface frames that are dedicated to the set of front-end module applications, and that when selected will initiate any one of the front-end module applications.

Still another aspect of the present invention provides a system and a method for collaboration, wherein the discussion module software applications is comprised of an object-based discussion manager, which generates discussion object that are associated with the computer-implemented system objects to enable discussion forums about the computer-implemented system objects.

A further aspect of the present invention provides a system and a method for collaboration, wherein the object-based discussion manager is an inherent part of the computer-implemented system, providing an object-based threaded discussion forum functionality for any computer-implemented system object.

Yet a further aspect of the present invention provides a system and a method for collaboration, wherein security for the object-based threaded discussions is based on object-based security set on a topic of discussion forum.

Still a further aspect of the present invention provides a system and a method for collaboration, wherein the summary module software application enables entity members of the computer-implemented system to have access to a summary of all data that are specific to an individual front-end module application, which span across all work zones.

Another aspect of the present invention provides a system and a method for collaboration, wherein the summary module software application enables the entity members of the computer-implemented system to generate front-end module application objects outside of a context of the work zone.

Yet another aspect of the present invention provides a system and a method for collaboration, wherein the document module software application enables entity members of the computer-implemented system to have access to documents, and includes security to prevent uploading of a corrupt document that may corrupt the computer-implemented system.

Still another aspect of the present invention provides a system and a method for collaboration, wherein the calendar module software application enables entity members of the computer-implemented system to have access to calendar objects.

A further aspect of the present invention provides a system and a method for collaboration, wherein the task module software application enables entity members of the computer-implemented system to have access to task objects.

Yet further aspect of the present invention provides a system and a method for collaboration, wherein the contact module software application enables entity members of the computer-implemented system to have access to contact objects.

Still a further aspect of the present invention provides a system and a method for collaboration, wherein the contact module software application contains contact information for member entities and non-member entities.

Another aspect of the present invention provides a system and a method for collaboration, wherein the instant messaging module application enables entity members of the computer-implemented system to have access to instant messaging objects.

Yet another aspect of the present invention provides a system and a method for collaboration, wherein the instant messaging module software application is instantiated by the entity member of the computer-implemented system to commence an instant messaging session, and where the computer-implemented system saves the instant messaging session into a work zone selected by the entity member.

Still another aspect of the present invention provides a system and a method for collaboration, wherein the instant messaging module application is instantiated by the work zone member within the context of a particular work zone to commence an instant messaging session, where the computer implemented system saves the instant messaging session into the particular work zone.

A further aspect of the present invention provides a system and a method for collaboration, wherein the electronic mail module software application enables entity members to have access electronic mail objects.

Yet a further aspect of the present invention provides a system and a method for collaboration, wherein the work zone includes the electronic mail module software application with at least one work zone aware electronic mail inbox therein, and where incoming electronic mail are directed to the at least one work zone aware inbox.

Still further aspect of the present invention provides a system and a method for collaboration, wherein the entity members are assigned a personalized electronic mail address.

Another aspect of the present invention provides a system and a method for collaboration, wherein the front-end module applications further includes at least an administration module application, wherein entity members are allowed access to functions related to administration of the computer-implemented system.

Yet another aspect of the present invention provides a system and a method for collaboration, wherein the administration module application further includes at least a site manager module application, wherein entity members are allowed access to functions related to site management of an entity member account.

Still another aspect of the present invention provides a system and a method for collaboration, wherein the computer-implemented system supports an offline version of the set of software application tools that integrate with an operating system of the access unit for allowing entity members of the computer-implemented system to function offline.

A further aspect of the present invention provides a system and a method for collaboration, wherein information generated within the set of software application tools while offline, is replicated and synchronized with the computer-implemented system the entity members reconnect to entity member accounts.

Yet a further aspect of the present invention provides a system and a method for collaboration, wherein the computer-implemented system provides Internet search functionality integral with the computer-implemented system.

Still a further aspect of the present invention provides a system and a method for collaboration, wherein entity members using the Internet search functionality are provided with results and a sponsored search listing, where upon selection of at least one sponsor from the sponsored search listing the entity members are directed to the selected sponsor advertisement web-site outside the computer-implemented system, and where the computer-implemented system is compensated by the selected sponsor for directing the entity member to the selected sponsor advertisement web-site.

Another aspect of the present invention provides a system and a method for collaboration, wherein the Internet search functionality provides both a local and a global search capability.

Yet another aspect of the present invention provides a system and a method for collaboration, wherein the local search capability provides search results with information that are local to a geographic area selected by the entity member.

Still another aspect of the present invention provides a system and a method for collaboration, wherein the back-end core applications are comprised of a data, access, handler, and manager layers, and cross-layer subsystems that include a security subsystem and a utility subsystem.

A further aspect of the present invention provides a system and a method for collaboration, wherein the data layer is a portion of the back-end core applications that stores data for use by the computer-implemented system.

Yet a further aspect of the present invention provides a system and a method for collaboration, wherein the data layer is comprised of a first component for sending, receiving, and storing messages, a second component for storing data, and a third component for storing files.

Still a further aspect of the present invention provides a system and a method for collaboration, wherein the second component is a relational database system for storing data, and the third component is a file storage system for storing data appropriately saved in file storage systems.

Another aspect of the present invention provides a system and a method for collaboration, wherein the relational database system is divided into two major sets of foundation and module tables, with the foundation tables including data related to infrastructure of the computer-implemented system and the module tables related to front-end module applications of the computer-implemented system.

Yet another aspect of the present invention provides a system and a method for collaboration, wherein the relational database system includes work zone identification data that relates the computer-implemented system objects to a particular work zone object, thereby making the computer-implemented system objects and any associated objects therewith work zone aware.

Still another aspect of the present invention provides a system and a method for collaboration, wherein the access layer provides access layer objects for controlling access to the data layer, and base-functionality for use in other layers.

A further aspect of the present invention provides a system and a method for collaboration, wherein the access layer is comprised of a first component access for accessing the first component of the data layer, a database access component for accessing the database component of the data layer, a file access component for accessing the file storage component of the data layer, a security access component for accessing a security component of the data layer, and a logging access component for providing a mechanism for reporting errors.

Yet a further aspect of the present invention provides a system and a method for collaboration, wherein the database access component of the access layer is comprised of initializer objects for resolving seemingly irresolvable conflicts, and destructor objects for handling processes of removing fundamental objects from the foundation tables of the data layer, and for providing a central method to store logic associated therewith.

Still a further aspect of the present invention provides a system and a method for collaboration, wherein the handler layer is comprised of handler objects that wrap functionality of the access layer objects, with each the handler layer object using the access layer objects to access a different component of the data layer.

Another aspect of the present invention provides a system and a method for collaboration, wherein the manager layer is comprised of manager layer objects that provide an interface used by the front-end module applications, and shield the rest of the back-end core applications from improper access.

Yet another aspect of the present invention provides a system and a method for collaboration, wherein all requests for connections to the data layer are generated by the manager layer objects, and passed onto the handler layer objects.

Still another aspect of the present invention provides a system and a method for collaboration, wherein the security subsystem provides complete control over the entity members and all computer-implemented system objects, and provide both external and internal security to the computer-implemented system.

A further aspect of the present invention provides a system and a method for collaboration, wherein the external security controls public interface with the front-end module applications, and is comprised of:
an encryption security module for encrypting all communication between the access unit and the server computer to ensure privacy;
a threat detection module that monitors and detects transmissible threats overall all data transmissions; and
an intrusion detection module that does network monitoring to diminish the impact of intruders.

Yet a further aspect of the present invention provides a system and a method for collaboration, wherein the internal security protect the data contained in the back-end core, and is comprised of:
an authentication module for authentication of entity members to access the computer-implemented system; and
a permission management module that facilitates an object-based security system for the computer-implemented system, where each the computer-implemented system object and entity member related to the computer-implemented system has the ability to have defined for the computer-implemented system object and the entity member individual user rights.

Still a further aspect of the present invention provides a system and a method for collaboration, wherein the object-based security system generates security objects, wherein association of the security object with the computer-implemented system objects enables authorized access to the computer-implemented system, and the computer-implemented system objects.

Another aspect of the present invention provides a system and a method for collaboration, wherein setting security on the computer-implemented system objects using the security objects automatically makes the computer-implemented system objects available to all entitled entity members of the computer-implemented system.

Yet another aspect of the present invention provides a system and a method for collaboration, wherein the association of the security objects with each computer-implemented system object is comprised of:
a) selecting entity members and groups of entity members to be associated with the computer-implemented system object; and
b) selecting a specific set of permissions for each of the selected entity members and groups of entity members to provide distinct, assign-able access rights to the computer-implemented system object;
   whereby the security object enables authorization and a varied level of allowed access rights and privileges to the computer-implemented system object.

Still another aspect of the present invention provides a system and a method for collaboration, wherein the object-based security system is an inherent part of the computer-implemented system, providing object-based security objects for any computer-implemented system objects.

A further aspect of the present invention provides a system and a method for collaboration, wherein every the computer-implemented system object is linked to one security object, and each the security object is linked to one computer-implemented system object.

Yet a further aspect of the present invention provides a system and a method for collaboration, wherein a plurality of computer implemented system objects are linked to one the security object, sharing analogous authorizations.

Still a further aspect of the present invention provides a system and a method for collaboration, wherein each security object enables an entity member to define access rights for each computer-implemented system object.

Another aspect of the present invention provides a system and a method for collaboration, wherein the computer-implemented system is one of a Web, Internet, Intranet, and Extranet based systems.

Yet another aspect of the present invention provides a system and a method for collaboration, wherein the computer-implemented system enables an authorized entity member instant access to up-to-date project related information without a need for synchronization.

Still another aspect of the present invention provides a system and a method for collaboration, wherein access to the computer-implemented system is through a single login into an account of the entity member.

A further aspect of the present invention provides a system and a method for collaboration, wherein the account set up for the computer-implemented system is comprised of:
collecting information about an entity;
selecting a vertical set of software application for the account by the entity;
collection of billing data, and verification of the collected data; and
redirection of the entity to access the account though the single login.

Yet a further aspect of the present invention provides a system and a method for collaboration, wherein the computer-implemented system is comprised of at least one server computer, within which the set of software application tools reside.

Still a further aspect of the present invention provides a system and a method for collaboration, wherein at least one server computer is accessed by the access unit through at least one of a secured and an unsecured communications protocols.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention.

Referring to the drawings in which like reference character(s) present corresponding parts throughout:

FIG. 1 is an exemplary systems overview illustration for accessing accounts, in accordance with the present invention;

FIG. 2A is an exemplary systems overview illustration for an account with a set of work zones and work zone members, in accordance with the present invention;

FIG. 2B is an exemplary systems overview illustration for a single work zone with a set of exemplary applications, in accordance with the present invention;

FIG. 2C is an exemplary systems overview illustration for adding of new members to various work zones, in accordance with the present invention;

FIG. 2D is an exemplary systems overview illustration for adding of applications or object to a work zone, in accordance with the present invention;

FIG. 2E is an exemplary systems overview illustration for the security and authorization rights for various members of a work zone, in accordance with the present invention;

FIG. 3 is an exemplary illustration of a general overview of the various components of the present invention;

FIG. 4 is an exemplary illustration of a data processing system in accordance with the present invention;

FIG. 5 is an exemplary illustration of a data storage unit (medium) in accordance with the present invention;

FIG. 6 is an exemplary illustration of the back-end core, in accordance with the present invention;

FIG. 7 is an exemplary illustration of the Data Layer, in accordance with the present invention;

FIG. 8 is an exemplary illustration of the Access Layer, in accordance with the present invention;

FIG. 9 is an exemplary illustration of the Manager Layer, in accordance with the present invention;

FIG. 10 is an exemplary illustration of the Security Subsystem Layer, in accordance with the present invention;

FIG. 11 is an exemplary block diagram illustration for setting accounts, in accordance with the present invention;

FIG. 12 is an exemplary block diagram illustration of the Summary Displays for the various modules (tools), in accordance with the present invention;

FIG. 13 is an exemplary block diagram illustration of a typical work zone display, in accordance with the present invention;

FIG. 14 is an exemplary block diagram illustration for the various tools available within a work zone display, in accordance with the present invention;

FIG. 15A is an exemplary block diagram illustration for the discussion module, in accordance with the present invention;

FIG. 15B is an exemplary block diagram illustration for an object based threaded discussion, in accordance with the present invention;

FIG. 16 is an exemplary block diagram illustration for the document module, in accordance with the present invention;

FIG. 17 is an exemplary block diagram illustration for the calendar module, in accordance with the present invention;

FIG. 18 is an exemplary block diagram illustration for the task module, in accordance with the present invention;

FIG. 19 is an exemplary block diagram illustration for the contact module, in accordance with the present invention;

FIG. 20A is an exemplary block diagram illustration sorting of emails within various work zones, in accordance with the present invention;

FIG. 20B is an exemplary block diagram illustration for the Email module, in accordance with the present invention;

FIG. 21 is an exemplary block diagram illustration for the administration module, in accordance with the present invention; and

FIG. 22 is an exemplary block diagram illustration for the site manager module, in accordance with the present invention.

### DETAILED DESCRIPTION OF THE INVENTION

(1) Introduction

Today, most groups working on projects collaborate most of the time using Email-centric collaboration software applications that inherit limitations that are inherent to Email systems. The present invention provides a system and a method that places the project being worked on at the center of the collaboration, and not emails. A project may be defined as a task, work, an undertaking, or any activity. With the project centric application of the present invention, Email becomes just one more tool for collaboration, rather than the means for it.

The present invention enables users to communicate and share project information through a single portal to a hub of collaborative applications and tools in a shared folder (a centralized space or a work zone), with each work zone dedicated to one distinct project, thereby eliminating the need for constant transmission/reception of information to achieve collaboration. The work zones include the Email application as just another tool for collaboration to communicate and share information. Emails and any other collaboration tools are accessed within a work zone, allowing communication and sharing of information with others to be within the context of a specific project.

The present invention integrates familiar applications into a common framework. When an authorized user launches an application from within a work zone, the work zone automatically records the history of each communication and information exchange created by the application that the user selected. All new project information (or any alterations thereto) is instantly organized and available to all authorized users in one centralized location. All authorized users are able to view the most up to date and orderly history of Email, instant message dialogs, documents, tasks, events, discussions, or any other collaboration tools used, all within the context of a project.

When new information is created and saved to a work zone, authorization may be provided to other entitled users to allow them to view the saved information. The present invention, therefore, combines messaging and collaboration applications into one platform, with a single login, real time communication, and constant connectivity. This allows all project information to be instantly organized and available to all authorized entities in one centralized location, overcoming most, if not all, inherited limitations of Email-centric collaboration software applications.

Before providing any more details regarding the various methodologies of the present invention, a system overview is provided, which describes the operation of various major components of the present invention in order to provide a more tangible understanding thereof without getting lost in the details. Next, a discussion section is provided in which the various major components presented in the system overview are discussed in detail.

(2) System Overview

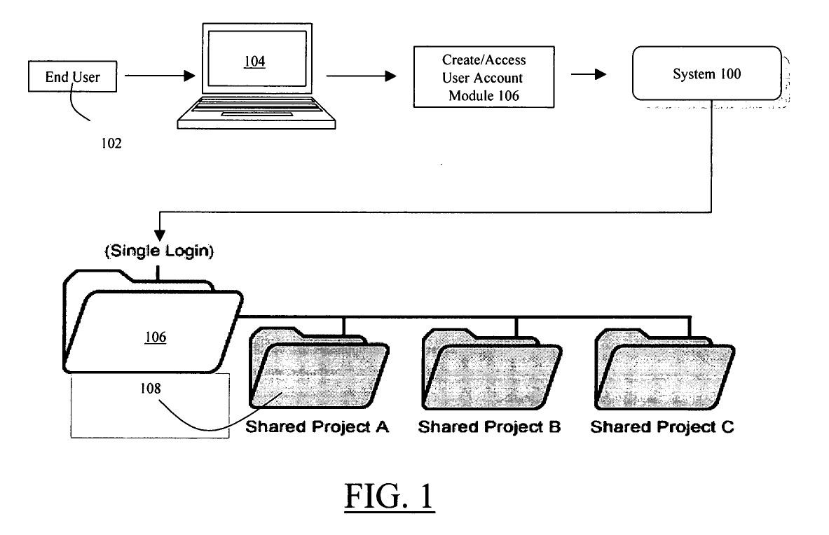

The present invention provides a network-based collaboration system (hereinafter system 100), which is a portal software application that enables a centralized starting place for access to consolidated collaboration related functions. As FIG. 1 illustrates, to access system 100 of the present invention, users 102 must first create and login to their user account 106 using any access unit 104. Upon accessing their accounts 106, authorized end users (members 102) may then create one or more work zones 108 for each project and or join one or more other work zones 108 already created by other members. The work zone structure keeps the information related to one project separate from information related to other projects, and makes it easy to organize and manage projects from a single interface.

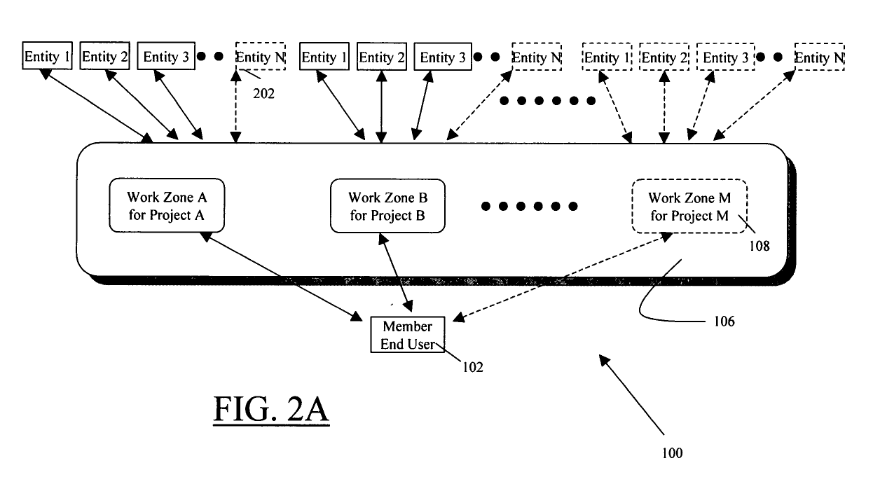

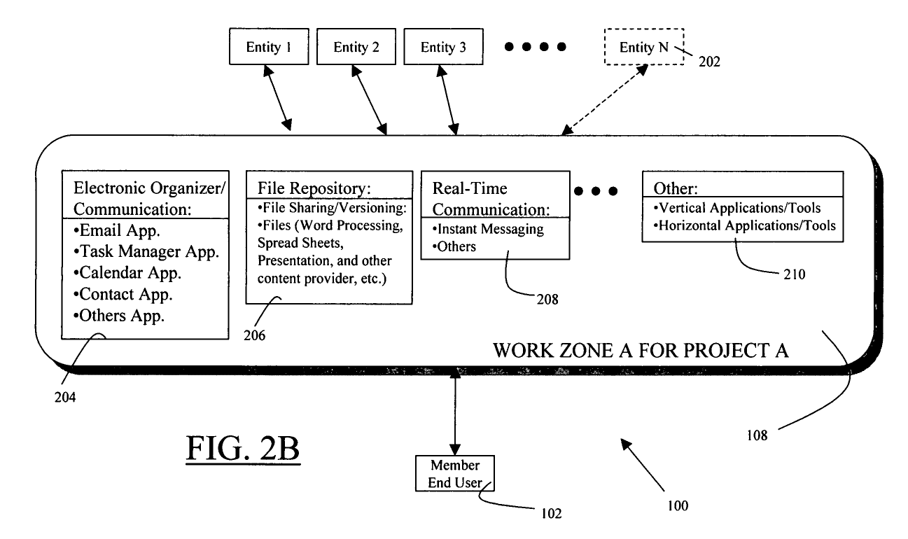

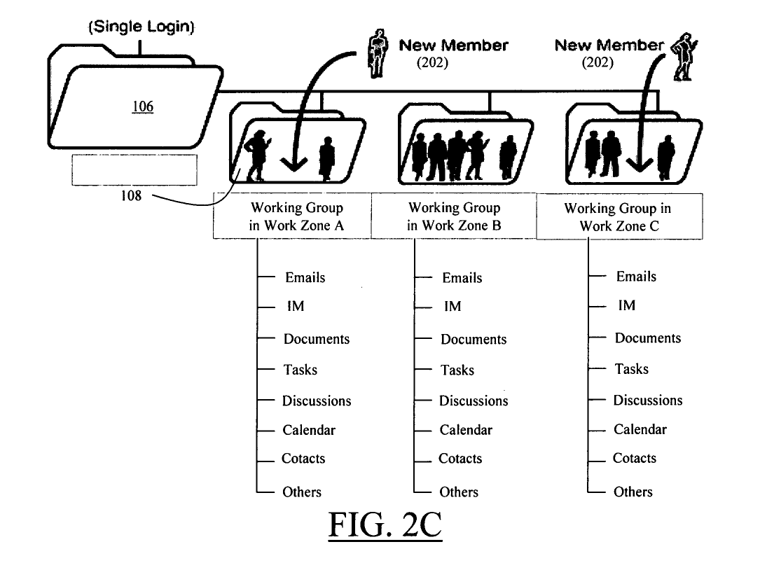

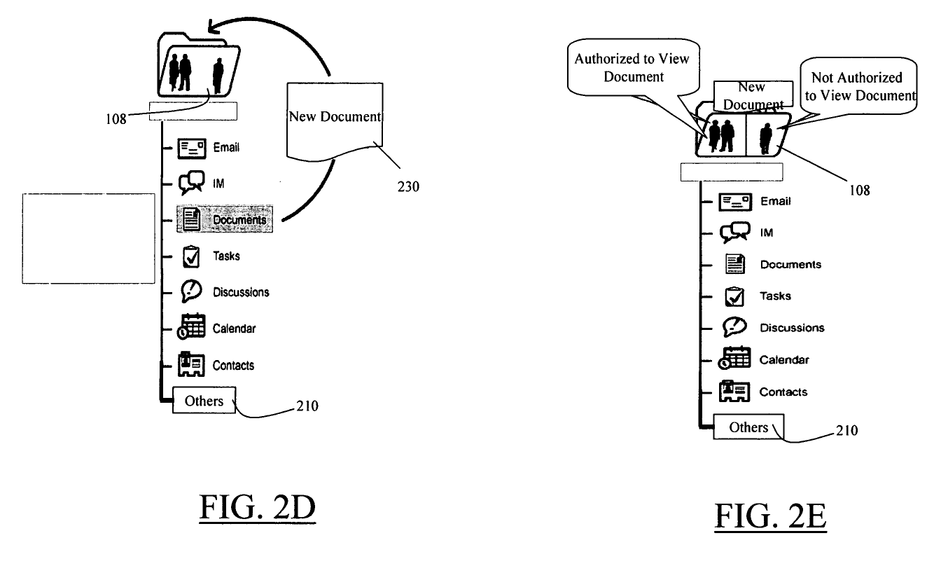

As illustrated in both FIGS. 2A and 2B, central to system 100 of the present invention is the work zone 108, which may be defined as a unified working zone of information. FIGS. 2A and 2B illustrate system 100 in relations to a single account creator/owner 102 for a particular project. In general, when an entity is signed-up with an account with system 100, that entity becomes the member of system 100. When an entity member also becomes a member or creator of a work zone, that entity member becomes a work zone member. Therefore, it should be noted that all entity members 202 would have similar account representation 106 with a set of work zones 108. It is only for clarity that the FIGS. 2A and 2B only illustrate the account 106 with its set of work zones 108 for one member 102. Therefore, most of the discussions in relation to member 102 are also applicable to other member entities 202. In addition, working group members of a particular project that are members of a work zone may also be collectively referred to as work zone members. The entity member(s) 202 may be individuals, organizations, and or other systems that have accounts and access rights, and are themselves members of the system 100. Throughout the disclosure the terms end-user(s), user(s), entity, member(s), entity member(s), and others may be used interchangeably for better readability. Regardless of the term used, it should be understood that any entity must have an account (or a guest account) to be considered a user or a member of the system 100. In addition, given that the entire system 100 security is granular, based on object-based security (described below), it should further be understood that every member (or account owner or holder) of system 100 will have varied individualized access rights, entitlement, or authorizations to system 100 and all objects therein. In general, an object is any entity within system 100 that can contain or manipulate data. Therefore, although not done for every instance for better readability, throughout the disclosure, the term “authorized” should be assumed to proceed any of the terms end-user(s), user(s), entity, member(s), entity member(s), and others, if such is not the case. For example, a user with granted rights to upload an object such as a document to a work zone may be considered an authorized user or an authorized entity member in relation to that document, with various access level privileges (if any) granted to manipulate that document.

Each work zone 108 is a project specific environment that enables access to many software applications and allows all applications to function collectively and collaboratively specific to a particular project, task, relationship or group. As illustrated in FIG. 2B, all applications 204, 206, 208, and 210 used for any particular project are used in the confines or within the context of a single collective community (work zone 108) that is dedicated to that particular project. All applications and tools reside in, and exist within the context of each work zone 108, and are work zone aware. Authorized work zone members may within each work zone 108 instantiated a set of applications based on the needs of the project for which the work zone was created. Each work zone 108 for each project will have its own complete set of work zone aware applications that members may select to create information. Integration of collaboration tools (or any tools required for a project) into each work zone eliminates the need to toggle between more traditional and disparate applications.

Each time a work zone member opens one tool from within a work zone 108, and uses a tool to create new information, the system 100 of the present invention sorts, organizes and saves the new information to that work zone. The system 100 can send an Email out of a specific work zone. The sent mail is automatically saved to that work zone, and the reply to that message returns to that same work zone. Therefore, Emails received from any member entity 202 or a reply from any entity for an exemplary project “A” will be directed to the inbox of the Email application within the work zone created for that project “A.” System 100 has the capability of supporting and integrating any type of a data container or application that contains or manipulates data, which includes both horizontal and vertical applications.

As further illustrated in both FIGS. 2A and 2B, a project may require a team comprised of several entity members 202 that contribute to that project. As FIG. 2C illustrates, the member 102 may assemble a project workgroup by inviting other entity members 202 into a work zone 108 dedicated to a particular project. The placement of distributed workgroup into a work zone 108 in this way unifies project members and their project into a single centralized location, making communication and sharing of information efficient. As a specific example, the project “A” may relate to logistical aspects for moving the equipment of a company with manufacturing facilities across several cities to another country, and the member 102 may be an employee of the exemplary moving company. Using the system 100 of the present invention, the member 102 may create a work zone “A” dedicated to this project “A,” and invite other entity members 202 (e.g., authorized employees from the member manufacturing company and or other colleagues from member 102 moving company) to join in the work zone “A.”

As illustrated in FIG. 2D, authorized work zone members with appropriate access rights may access or create a work zone 108, or may access, create, and or import a specific application or object within the work zone 108, such as the exemplary document 230. As FIG. 2E illustrates, the authors (creators) of any object or information with appropriate access rights may set permission to decide which work zone members can access a particular object within the author's work zone as it is saved to the work zone. Therefore, as members of a work zone, each would only view the information as the other work zone members' permit. In effect, members will have their own unique view of each project.

Any new information is automatically organized and instantly available to all entitled work zone members. Because the communication and sharing of project information occurs online within a work zone architecture, the authorized work zone members can always see the most up to date information. For example, if authorized, the work zone members may access the electronic organizer/communication applications 204 (illustrated in FIG. 2B) within the work zone “A” to view, send, and or receive information over an Email account that is dedicated to exemplary project “A.” The authorized members of work zone “A” may input date sensitive information into a calendar application dedicated to the project “A” (such as a moving date from a particular city to the destination country). They may use file sharing/versioning to view or post a particular content provider application (such as the exemplary document 230 that may represent a spreadsheet for costs associated with moving from each of the cities to the destination country) for other authorized members of the work zone “A” to view and or edit, and perform other authorized work related activities with other applications 210 (such as vertical applications developed exclusively for a moving company). All applications within system 100 are “aware” of their content (data) or their content's relationship to other applications and their respective contents within the project “A.” That is, they are aware of the organizational unit (work zone) that their data belongs.

The system 100 through work zones 108 provides tools for automated collaboration between applications or other users. One of ordinary skill in the art would appreciate that the described system exponentially reduces the complexity of a typical user's workload when the number of projects and or work collaborations between colleagues increase. If a member 102 works on several projects with a number of different colleagues simultaneously, the member 102 will not be overwhelmed by the amount of information that the member 102 must organize and aggregate, such as tracking each individual Email, calendar event, instant messages received or sent, and other applications 210, and would not require to associate (categorize or organize) them in relations to a particular project and or colleague. For example, the member user 102 may work on the exemplary moving project “A” within work zone “A,” and work on a completely different project (e.g., project related to maintenance of all in-house equipment, named as project “B”) with a completely different set of entity members 202 (such as mechanics, suppliers, other vendors) and application requirements. Electronic mails received from entities 202 related to project “B” (say from mechanics) will route to the inbox of the email application residing in work zone “B,” and those received from other entities 202 related to project “A” will be routed to the inbox of the email application in work zone “A,” all within system 100 of the present invention..

Work zones 108 also provide a collaborative environment that can be used to manage and organize all projects, processes and relationships within an organization. The organizational model of the work zone 108 framework allows team members to find information quickly by giving them the ability (with appropriate access rights) to search across all of their work zones 108 through a summary module, as well as search within a single work zone 108. The work zones 108 allow users to quickly and easily organize and locate related information, set permissions on any object to maintain the security of sensitive information, reuse common business processes with work zone templates, and assign role or object-based security to provide only the necessary actions to members of a work zone 108.

Every collaboration item is instantly organized within a work zone 108, allowing work zone members to participate in large number distributed teams, effortlessly. The flexible work zone templates increase the efficiency of an enterprise through knowledge sharing and the reuse of best practices. Work zone aware objects have the ability to be moved between work zones 108, and users with accounts and with the necessary permissions can create a personal work zone 108 that can be used to save all objects that are exclusive to that user or project. The user not authorized to create the personal work zone 108 may or may not know if the work zone 108 actually exists and may or may not be allowed to add other users.

As stated above, a work zone 108 may include both horizontal and vertical applications. A horizontal application is one that can be applied to the collaboration of almost any project or organization. As industries that are optimal for system 100 are determined (for example based on their profile information when setting-up accounts 106 with the system 100), the application can be pre-configured to more accurately meet the needs of any specific industry. These pre-configurations along with work zone-aware tools that are useful within the industry are considered a vertical (or verticalization of the system 100). Various aspects of system 100 can be verticalized, the non-limiting examples of which may include terminology, security settings, group settings, account settings, work zone templates, object templates, etc.

The software applications within work zone 108 may comprise of any type of both vertical and horizontal software, the non-limiting, non-exhaustive examples of which may include electronic organizers/communication applications 204, file repository applications 206, real time communication applications 208, and other vertical and horizontal applications and or tools 210. Non-limiting, non-exhaustive examples of electronic organizer/communication applications 204 may include work processing software, organizer software, email, e-fax, web conferencing, video conferencing, voice conferencing, instant messaging, or voice mail, and non-limiting, non-exhaustive examples of file repository applications 206 may include shared whiteboard, application sharing, subscriptions/alerts, etc. However, all content management and provider applications are used and accessed within a single work zone 108 dedicated to a particular project 100. The system 100 enables entities (e.g., member 102) to set up these virtual work zones 108 to share and to collaborate all aspects of any of the projects I 00 with other entities 202. The integration of all services is accomplished through an exemplary web interface. With system 100, the member users 102 will not be faced with continually increasing cost of deploying, maintaining, and managing the applications because the present invention may be implemented using the Internet, resulting in savings of valuable resources.

(3) Discussion

The discussion section first provides a data processing system overview to acquaint the reader with the various components typically found in a data processing system that may be used in conjunction with system 100, and a set of software application collaboration tools that is comprised of a back-end core, which describes the kernel of system 100, and front-end module applications that describe the graphic user interface (GUI) of the present invention.

(A) Data Processing System Overview

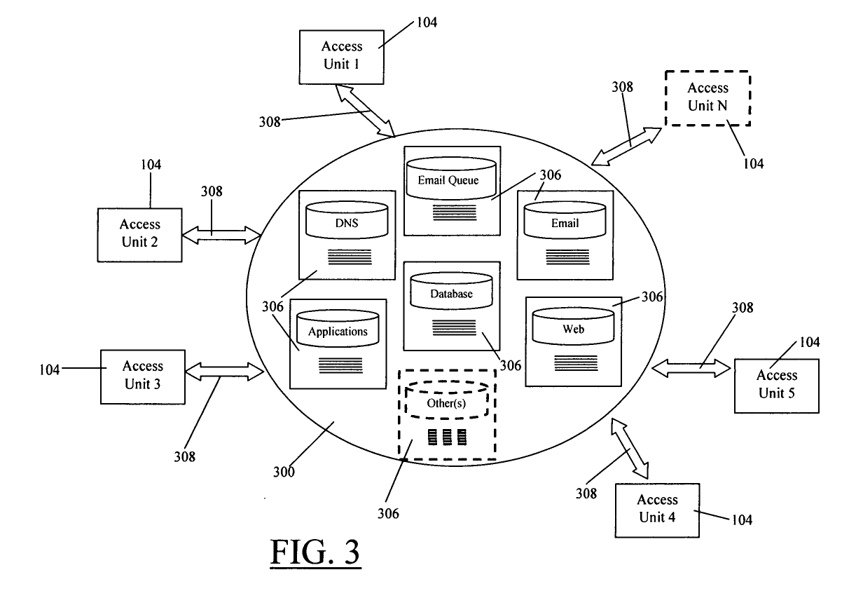

A block diagram depicting the exemplary data processing system components used in the present invention is illustrated in the exemplary FIGS. 3, 4 and 5. For purposes of illustration, programs and other executable program components may be illustrated herein as discrete blocks, although it is recognized that such programs and components may reside at various times in different storage components, and are executed by the data processor(s) of the computers. FIG. 3 is an exemplary illustration of a general overview of the components used in system 100 of the present invention that creates and facilitates an online community of users with common interests through a variety of servers 306. The term relationship may be defined in terms of projects, business to business relationships, business to clients, or in general entity to entity relationships.

Although only a few servers 306 are illustrated for simplicity, it should be understood that any number of servers and backup units may be used for each application and or database. In addition, a single server may also house several applications and or databases. Every sub-system within hardware system 300 comprises of actual software component and a server where the software resides. It should be understood that the illustrated servers 306 such as the Web server, the Domain Name Server (DNS), Database server, and so on are not an exhaustive and complete listing of all the servers used, and are merely examples of the types of servers/applications that may be required by the system 100 of the present invention. In addition, there is a client level application that is maintained within the various accesses units 104. As illustrated, end-users 102 may access system 100 through a presentation code (described below) displayed by users' browsers on any access unit 104, the non-limiting examples of which may include a desktop computer, Laptop, Notepad, wireless systems such as Personal Digital Assistant (PDAs), or any other access units 304 capable of viewing or executing system 100 functions.

In general, the user may communicate by a variety of protocols 308, the nonlimiting examples of which may include any Internet based protocol for accessing hardware 300 of system 100. This may include an unsecured connection such as for example a hypertext Transfer Protocol (HTTP) or a secure one such as a Secure Sockets Layer (SSL). SSL is an encryption protocol applied to HTTP traffic to ensure integrity and privacy. With this illustration, the users may represent any entity, including individuals, other systems, and or businesses, each authorized with different levels of access privileges to system 100, based on the system provider. Data is stored using relational databases and disk subsystems such as Direct Attached Storage (DAS), Network Attached Storage (NAS), Storage Area Networks (SAN), or others.

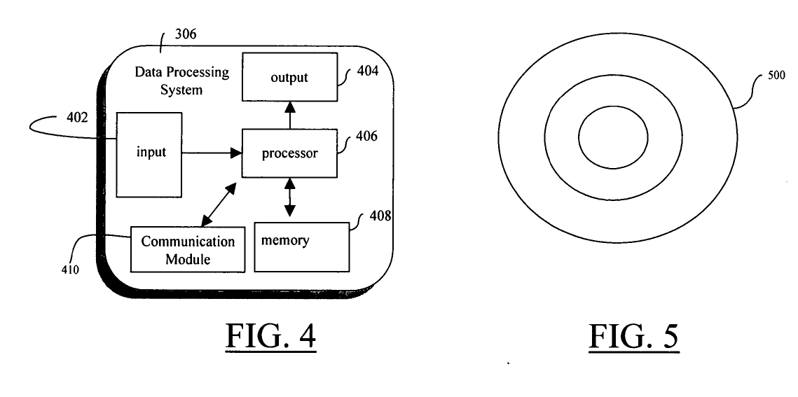

As further illustrated in more details in FIGS. 4 and 5, the data processing systems used in any computing device illustrated in FIG. 3 may comprise an input 402 for receiving data, the non-limiting examples of which may include a communication module 410, an external computer (not shown) connected to the system 406, an Internet connection, or any device capable of receiving a computer readable medium 500 (illustrated in FIG. 5) such as a floppy disk, Compact Disk (CD), a Digital Versatile Disk/Digital Video Disk (DVD), and or a removable hard drive. The input 402 may also be configured for receiving user input from another input device such as keyboard, a mouse, or any other input device best suited for the current environment conditions. Note that the input 402 may include multiple “ports” for receiving data and user input, and may be configured to receive information from remote databases using wired or wireless connections.

The output 404 is connected with the processor 406 for providing output to the user, possibly through a voice or video display. Output 404 may also be provided to other devices or other programs, e.g. to other software modules, for use therein, possibly serving as a wired or wireless gateway to external databases or other processing devices or communications nodes. The input 402 and the output 404 are both coupled with a processor 406, which may be a general-purpose computer processor or a specialized processor designed specifically for use within a particular environment. The processor 406 is coupled with a memory 408 to permit storage of data and software to be manipulated by commands to the processor.

The set of software application collaboration tools that is comprised of the back-end core of system 100, and the front-end module applications is described below.

(B) The Back-End Core 600

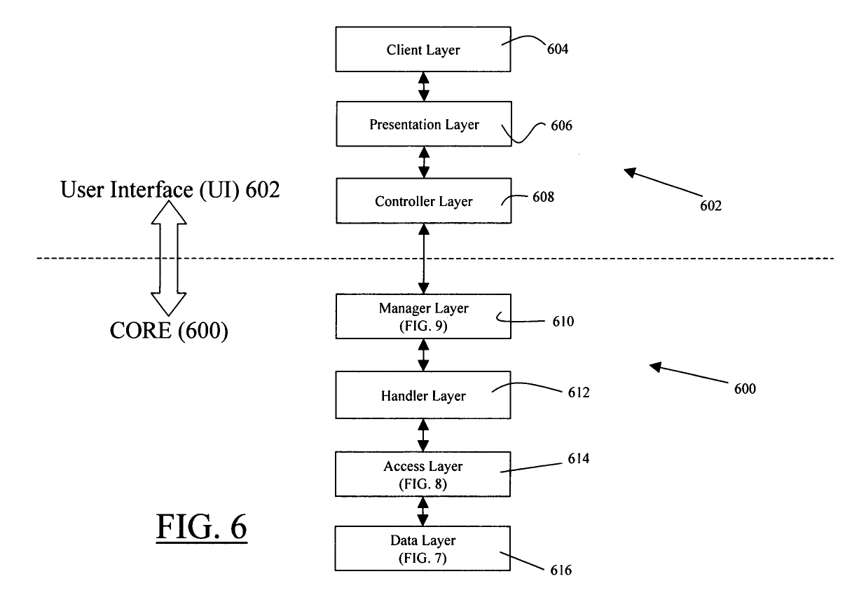

As illustrated in the exemplary FIG. 6, the Core 600 is effectively half of the functional system 100 of the present invention, with the other half being the GUI 602. The Core 600 is in general responsible for all data-related actions, non-limiting examples of which may include retrieval, storage, and the protection of the integrity of all data. When users retrieve, store, or manipulate data in the present invention, it is the Core 600 that does all the work. On the other hand, analyzing, sorting, rearranging, and displaying this data is in general the responsibility of the GUI 602. The Core 600 uses a series of structures to abstract the data stored in system 100 to make it easier for the GUI 602 to work with the data. The Core 600 is described first to provide a better understanding of the means by which the GUI 602 does its work, including the method by which objects within a work zone become work zone aware. First, a general description of the entire Core 600 is provided, followed by a detailed description of each layer.

The lower section of FIG. 6 (below the dashed line) illustrates the overall structure of the Core 600. In general, the Core 600 is engineered using a layered model in which each layer only uses the layer immediately below it. There are a few exceptions to this rule, but it holds true most of the time. As a layered application, only the highest layer 610 of Core 600 is used externally, with little (if any) knowledge of the underlying layers is necessary in order to use the Core 600.

The Manager Layer 610 is primarily responsible for managing and coordinating data connections and transactions, and passing data back up to the front-end module applications GUI 602. The Manager Layer 610 is responsible for presenting a standard interface to the layers above it. Each Manager object instantiated to handle a stream of data cascaded down from the upper layers, calls and instantiates appropriate data handler objects residing in the Handler Layer 612. Only the Manager Layer 610 uses the Handler Layer 612 methods directly. Every data handler object called and instantiated is then responsible to access and manipulate the actual data through the Access Layer 614. In general, each handler object is responsible for manipulating data in a single table (in the Data Layer 616). Managers that do work on multiple tables of the Data Layer 616 typically use a separate handler object for each table.

The Access Layer 614 is typically used only by the Handler Layer 612. The Access Layer 614 is primarily responsible for controlling access to the Data Layer 616. All access to the Data Layer 616 is done through the Access Layer 614, without exception. Any time a handler object needs some work done in the Data Layer 616 it will use objects in Access Layer 614 to do the work. The Access Layer 614 is therefore called and instantiated by the Handler Layer 612, which further separates each data stream from each individual data handler for actual manipulation of the database, file system, etc. in the Data Layer 616. The Access Layer 614 passes the data stream to the appropriate stored SQL procedure in the database within layer 616. These SQL procedures use key terms and link tables in the data stream passed on to link or relate one or more tables using the primary and foreign keys associated with specific rows in database tables, providing a record-set, where the data may then be saved or retrieved.

Layers 606 to 612 are hard coded, i.e. with each layer having specifically coded program to handle various functionalities within and contiguous layers. Hence, appropriate programs within a layer are called and instantiated by an immediate adjacent layer for every data stream cascaded downward or upward to or from Client Layer 604 and the Handler Layer 612 for performing the required tasks. The Access Layer 614 does not instantiate any programs, it simply forms a connection to the Data Layer 616 through an appropriate API technology. The Access Layer 614 is therefore responsible for protecting the Handler Layer 612 from the details of communicating with the Data Layer 616.

It should be noted that upper layers instantiate lower layers—for example, the Presentation Layer 606 (within the GUI 602) will instantiate a Controller Layer object which will in turn instantiate Manager Layer object, which will in turn instantiate Handler Layer object, which will in turn use the Access Layer to access the data in the Data Layer 616. Rarely, if ever, will a lower layer object be responsible for instantiating an upper layer object. It is possible, however, for same-layer objects to instantiate each other. For example, a handler object in rare instances, may be responsible for encapsulating another handler object which would require a handler object to instantiate a handler. Another example would be a Manager Factory instantiating a Manager—both objects are part of the Manager Layer 610.

The following paragraphs describe each of the Core 600 layers in detail, from bottom—up.

(i) Data Layer 616

The Data Layer 616 is the portion of the Core 600 that stores the data for use by the rest of the application 100. All data going up from the Core 600 comes from the Data Layer 616, and all data going down into the Core 600 goes into the Data Layer 616. The majority of data in system 100 is stored in one or more databases, and some are stored in files. The files are stored on a server 306 accessible by the Core 600. Non-limiting examples of items stored in files rather than in the databases are images, Cascading Style Sheets (CSS), Extensible Markup Language (XML) configurations, or any other data that is best suited to be stored in a file system. Besides databases and file storage, other components or information that may be within Data Layer 616 may include communication protocol software such as Simple Mail Transfer Protocol (SMTP), and the like. Since Data Layer 616 is responsible for all information inbound and outbound from the Core 600, any data-related components is added to this layer.

Most communication with the databases in the Data Layer 616 is done via stored procedures, and therefore, tables and data are rarely accessed directly. The databases and file systems may be comprised of any industry standard relational database system that enables efficient management, manipulation, and distribution of data, as well as file storage systems such as DAS, NAS, and or SAN technologies. The databases and file systems within Data Layer 616 represent any application residing on any of the servers in the form a relational database, and may run on servers 306 using any industry standard operating system. The connection of servers 306 is by industry standard methods, nonlimiting examples of which may include an Ethernet, Infiniband, etc.

The relational database within the Data Layer 616 is comprised of one or more tables of data “related or linked” together through well-known database programming principles, including the use of primary and foreign keys—a capability inherent in most relational database systems. In general, a primary key identifies one or more columns whose values uniquely identify a single row of data in a table. In general, the database automatically generates the unique values associated with primary keys. Foreign keys in a relational database represent values that point to a primary key in another table. A foreign key in one table points to an exact row of data in another table. Relational databases within Data Layer 616 are built using well-known normalization techniques. Normalization is a process of eliminating duplicate data and providing a fast, efficient search path to it. The Database layer 616 includes industry standard Structured Query Language (SQL) procedures for retrieving data therefrom. SQL is the language understood by most relational database systems, comprised of statements (or procedures) written in specific syntax that enable communication between programs, end-users, and the database. SQL uses key terms and link tables in a query to link or relate one or more tables using the primary and foreign keys associated with specific rows in those tables to create a virtual table (known as a view) containing a record-set (the “answer”) to the query. The views are often used, but not always. The use of a view depends on the specific type of record-set being requested.

Both the presentation code (GUI) and the Core may be written in any well-known (scripting and or non-scripting) programming languages, including any standard object oriented language. In addition, the actual SQL statements may be dynamically built and executed directly from the code or in the relational database. Dynamic pages provide a server-side development environment and allow for the use of variables with session scope—a session may commence with the logging in of a user and may have a limited duration. Hence, variables with a session scope may retain their values for the entire session. Server computers such as those illustrated in FIG. 3 interpret and execute any server-side code on the page before they send it to the client-side (the user browser or other client) on the top level, with the result that the client may receive a non-limiting, exemplary Hyper Text Markup Language (HTML) page.

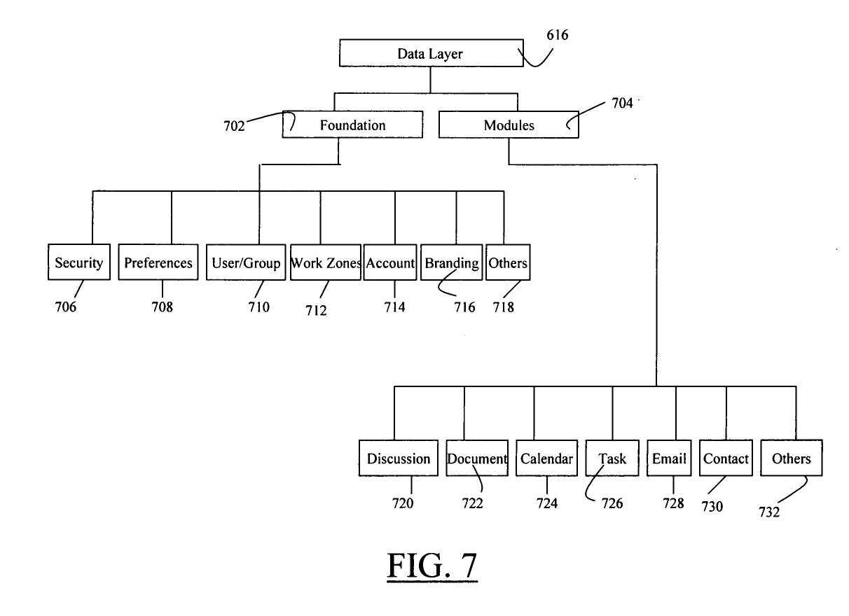

As illustrated in FIG. 7, the tables in the databases of the Data Layer 616 can be grouped into foundation tables 702, which are the infrastructure of the system 100, and module tables 704 that store most of the user data. The foundation tables 702 comprise of security tables 706 that allow authorized access to data as appropriate. The Preference tables 708 maintain settings for users between sessions, and the User/Group tables 710 track all groups in the system and their users. The work zone tables 712 organizes user data into separate logical groups, and Account tables 714 tracks all accounts in the system 100 and their related information. The Branding tables 716 store the user custom look and feel settings for the GUI. Other tables 718 may be used for other vertical or horizontal applications.

The module tables 704 of the relational databases in Data Layer 616 comprise of Discussion tables 720 that allow users to save discussion sessions, and Document tables 722 that allow saving of documents within the system 100. The calendar tables 724 are used to save information that track events, meetings, and so on, and the task tables 726 enable tracking and savings of task(s) for which the work zone was created, such as their status in relation to the level of completion of a task. The Email tables 728 contain information related to emails. The Contact tables 730 store user address book entries. The other tables 732 may be used for other vertical or horizontal applications, such as instant messaging, etc.

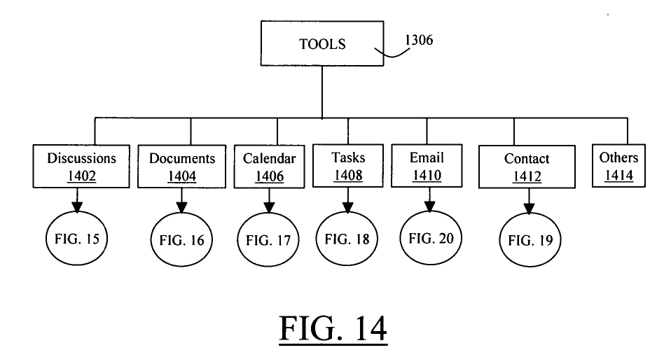

All individual illustrated components (706 to 732) are comprised of a plurality of tables and objects. For example, the Contact module 1412 (in FIG. 14) may comprise of several Contact tables 730, the Security system tables 706 may comprise of even more tables, etc. Each of the foundation 702 and module 704 tables function independently from each other, but most communicate with the foundation tables 702. Foundation 702 and Modules 704 tables, and their respective collective tables (706 to 732) do not share information, except for the information they are required to share in order to function, such as user and account information stored in the foundation tables 710 and 714, respectively, or any other combination of tables or sets of tables that requires sharing of information.

The implementation of work zone aware objects within system 100 can be done using several methods, a non-limiting example of which include the use of inserting a work zone identification in the table of individual modules or objects created. That is, individual entries into the database that are related to objects within a work zone are tagged with a work zone identification that correlates the object to that work zone, hence making the object work zone aware. When a work zone 108 is selected by member, all objects related to that work zone (having the work zone identification) are retrieved from the various databases or tables thereof. In addition, the system 100 of the present invention may also include master work zone tables that act as a filter for all the other tables. Therefore, as an example, the calendar in work zone “A,” is aware that it belongs to work zone “A” because of the tagged ID of the work zone “A” that the calendar in that work zone incorporates within the database.

(ii) Access Layer 614

In general, relational databases and file systems represented, do not directly communicate with higher level applications. In order to establish a communication link between higher level applications and the relational databases and file systems of the Data Layer 616, various industry standard applications programming interfaces (API) may be used. These are framework modules that are used by the software to implement the specific data Access Layer object 614, comprised of objects with abstract responsibilities. The Access Layer 614 therefore encompasses objects related directly with accessing support sub-systems external to the application such as the SMTP server, the database or the file systems of the Data Layer 616. Each API is designed specifically to access and expose features of its corresponding connected relational database store to authorized users according to predefined parameters. These may include, but should not be limited to, for example, specific security configurations, IP addresses, port numbers, and other standard changes specific for the location and requirements of the system.

Referring back to FIG. 6, the Access Layer 614 wraps the Data Layer 616 information, and provides additional base-functionality for use in higher layers. Access Layer 614 is primarily responsible for controlling and performing all activity involving access to the Data Layer 616 (e.g. the database, files, SMTP, etc.). All access to the Data Layer 616 is done through the Access Layer 614, without exception. Any time a Handler object (from the Handler Layer 612) needs some work done in the Data Layer 616 it will use objects in the Access Layer 614 to do the work. The Access Layer 614 also provides security access functionality, initializers (responsible for “bootstrapping” the system 100), and destructors (responsible for disposing of complex objects in the Data Layer 616).

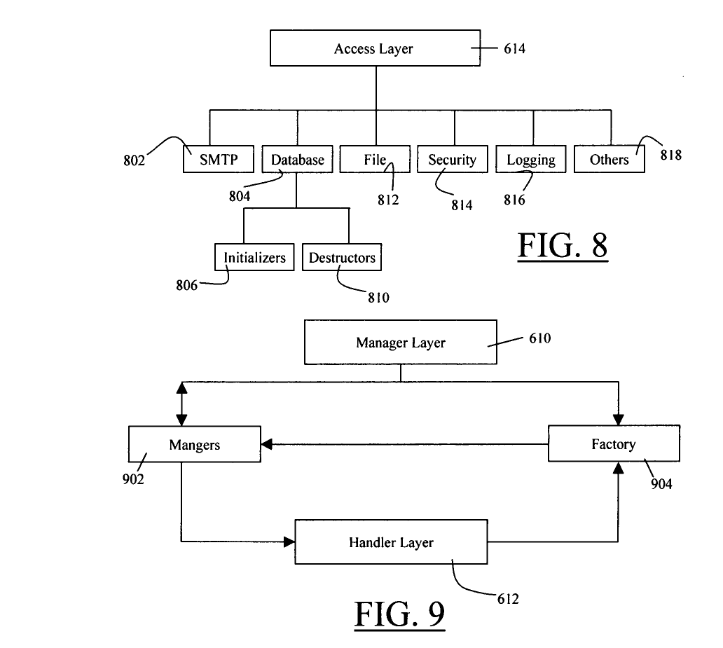

As illustrated in FIG. 8, the content of the Access Layer 614 comprises the SMTP Access 802, which wraps the SMTP-portion of the Data Layer 616. The SMTP Access 802 provides both static and instance methods for sending Email. The Database Access 804 wraps the database-portion of the Data Layer 616, and further includes Initializers 806, which are responsible for “bootstrapping” the system 100. The Initializers 806 bypass the normal creation process (of an account, for example) in order to resolve seemingly irresolvable conflicts. The Destructors 810 of the Database Access 804 are responsible for handling the processes of removing fundamental objects from the database, and provide a central method to store the logic associated therewith. Non-limiting examples of fundamental objects may include Account, Work Zone, Users, etc.

The File Access 812 wraps the file system portion of the Data Layer 616, and is comprised of a special set of objects (or “helpers”) that enable access to any files from the Core 600. Just as the Database Access 804 enables access to data within the databases, the File Access 812 enables access to files stored within the Data Layer 616. The Security Access 814 provides object-level security for the Data Layer 616, and the Logging Access 816 provides a method to log incidents without having to worry about the details of the logging framework. That is, the Logging Access 816 provides a method by which system 100 can report errors, debug information, and other useful feedback while the program is running. The Others Access unit 818 may be used for accessing other data types.

(iii) Handler Layer 612

Referring back to FIG. 6, the Handler Layer 612 is responsible for wrapping the functionality of the Access Layer 614 in an easier to use, more robust set of objects. The objects in the Handler Layer 612 use the Access Layer 614 to do all their work. The Handler Layer 612 contains the set of all the handlers in the Core 600. Each handler object uses a component of the Access Layer 614 to access a different component of the Data Layer 616, and since most of the Data Layer 616 is comprised of the databases, most handler objects are responsible for accessing database objects. Each handler object accesses a different type of database object. It should be noted that handler objects expose properties, but not methods for manipulation by the GUI through the Manager Layer 610.

(iv) Manager Layer 610

The Manager Layer 610 is the outer most layer of Core 600, and provides the bulk of the interface that will be used by the front-end module applications GUI 602, and shields the rest of the Core 600 from improper access. The Manager Layer 610 is essentially a wrapper for the Handler Layer 612, and the Handler Layer 612 is used to do the bulk of the work for the Manager Layer 610. As better illustrated in FIG. 9, the Manager Layer 610 is comprised of a Manager component 902 and a Factory component 904. Managers 902 and Factories 904 can be derived to provide variations of the Manager Layer 610 objects that cater to specific needs. Handler Layer 612 components are accessed via their containing Manager 902. Update and Remove functionality for the Handler Layer 612 is accessible only through the Manager Layer 610, which wraps the internal functionality of the handler objects.

The Handler Layer 612 components (or objects) are instantiated by factory objects 904 that then wrap the Handler Layer 612 component in a manager layer object which is also instantiated by the factory object 904. The “Add” functionality, as well as “Get” functionality is handled by the factory objects 904. Add functionality takes Handler Layer 612 objects that have been instantiated and populated by the GUI 602 to carry out the task of adding (data or information). Each manager object 902 contains one or more underlying handler objects that it uses to do its work. Factory objects 904 provide a means by which to generate manager objects 902 and the underlying handler objects they need to do their work. Since factories 904 only generate a single type of manager 902, and managers 902 need a factory 904 to generate them, it makes sense that there is generally a one-to-one relationship between managers 902 and Factories 904.

As stated above, in addition to wrapping Handlers, the manager objects 902 and the factory objects 904 are also responsible for handling connections and transactions. All connections to the Data Layer 616 are created in the managers 902 and factories 904. When a handler object needs a connection to perform a task, the connection is passed down from the manager 902 or the factory 904 into the handler object. When the manager 902 (and its underlying handler object) is done doing the work, the manager 902 closes the connection. Similarly, managers 902 and factories 904 are responsible for managing transactions, all of which are initiated and closed by the managers 902 and factories 904.

(v) Core 600 Substructures

In addition to the various Core 600 layers illustrated in FIG. 6, the Core 600 also comprises of various substructures or subsystems that do not neatly fit into any of the illustrated layers. For example, although not illustrated, the Core 600 includes a utility subsystem that contains a set of common utility objects that assist the other Core 600 layers in doing their work. The utility subsystem exposes access to the Access Layer's logging system, which is used by the Manager, Handler, and or Access Layers. The utility subsystem also exposes the identification system, which is responsible for handling the packaging of primary and foreign keys throughout the core 600 layers in a secure manner. The utility subsystem can also expose the core 600 centralized exception handling system, which is responsible for handling all core 600 exception.

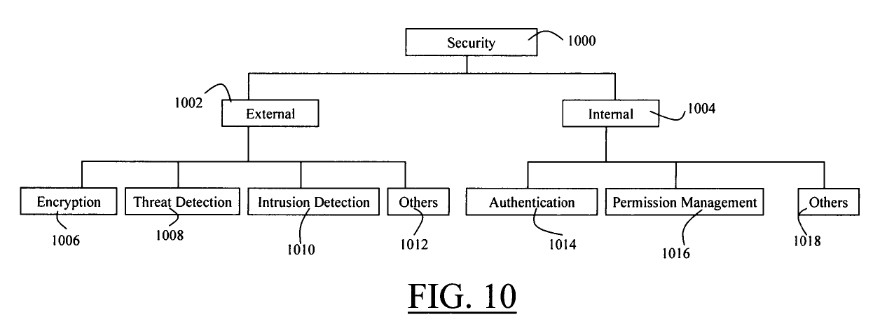

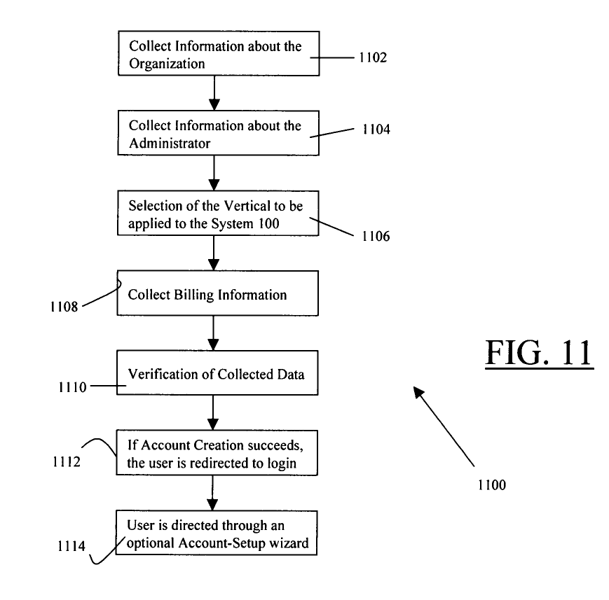

The security substructure 1000 illustrated in FIG. 10 is another subsystem of the Core 600 that cannot be categorized in between any Core 600 layer. The security system 1000 provides complete control over any person or program accessing the system 100, and provides both external 1002 and internal 1004 securities. The external security system 1002 is comprised of an encryption security module 1006, which enables all communication between the clients 104 and the servers 306 to be encrypted to ensure the privacy of the data within system 100. Any standard encryption technology may be used, the non-limiting examples of which may include the Secure Socket Layer connections. The external security system 1002 further incorporates a Threat Detection module 1008, which monitors and detects transmissible threats (e.g., viruses, etc.) over all data transmissions (e.g., email, documents, etc.). Inbound, outbound, and internal communications are monitored for viruses and other transmissible threats using the Thread Detection security module 1008. As illustrated, the External Security system 1002 further includes an Intrusion Detection module 1010, which does network monitoring to diminish the impact of intruders by identifying them early on during the intrusion. Other security modules 1012 further aid in providing secure communication and work environment between clients 104 and servers 306.

The Internal security system 1004 illustrated in FIG. 10 provides protection for the data contained within the system 100. For example, it limits access to the data, and includes an Authentication module 1014 that ensures only authorized users access to and or use of system 100. Using the Authentication module 1014, system 100 does not allow access to any data or methods in the system 100 unless the end users are authenticated.

The security for all objects within system 100 of the present invention is object based, where each object in the system 100 can be assigned users or groups of users which are granted rights, such as edit, read-only, delete, view, and so on. Object based security provides every single object within the system 100 assignable rights. The object can be any entity within system 100, non-limiting examples of which include a work zone, a user, a file, an email, email account, a specific document, the account itself and so on. The Permission Management security module 1016 includes the object-based security system that allows access to data that the users have permission to access. Data access is controlled on a user-by-user, object-by-object basis. No user may access any data or object without first passing a security check that compares their rights to the required rights of data or objects. This completely restricts users to accessing only the data that they have explicitly been given permission to use. In general, every object in the system is linked to one (and usually only one) security object. Inversely, each security object in the system is linked to one (and usually only one) piece of data in the system. However, it is possible to have an unlimited number of objects linked to a single security object. All objects linked to the same security object would share the same permissions. A security object linked to data, in combination with other security schemes within Core 600, enables authorization and a varied level of allowed access to the data that the security object is linked.

Object based security means that each object or entity within system 100 has the ability to have defined for the object or the entity individual user rights. With the object-based security system, users can share access to other users objects, the non-limiting examples of which are summary module, calendar, task, documents, or any other tools 1306 available to users who need to know others schedules, tasks, content of documents, and so on while maintaining the privacy of personal meetings or other information. Because the security is object based, it provides a unified security model for all of system 100. Every object has similar GUI for its security, such as a security tab GUI that when selected displays a security frame GUI with security options to be selected for that object, such as permissions for adding multiple users and or groups to view, edit, delete and or perform other functions to that object. The security implemented for system 100 is not a database security. However, as illustrated in FIG. 7, the security information is stored in one or more security tables 706 of the database within the Data Layer 616.

Other, less preferred security modules 1018 may also be used, a non-limiting example of which may be security based on roles and distribution. Roles may be thought of as job functions, and are divided into two well known, broad categories of system-defined roles and user-defined roles. Role based securities are well known.

(C) The Front-End Module Applications—Graphic User Interface 602

Referring back to FIG. 6, the Client Layer 604 is comprised of a thin client, the non-limiting examples of which may include any well-known web browser, or a consumer of a web-service. The Client Layer 604 may be accessed by any access unit 104 illustrated in FIGS. 3 to 5. As with any other web based application, system 100 of the present invention does not push content onto a user's browser, end-users need to pull content by refreshing their browser screen. System 100 can be accessed through Client Layer 604 through a limitless number of technologies, non-limiting, and non-exhaustive examples of which may include HTML web browsers, Macro Media Flash Client, mobile phones, pagers, PocketPC/Palm-Pilots/PDAs, telephone (voice based E-mail, etc), consumption of system 100 Web Services in third-party client applications or web-applications (i.e., integrating system 100 functionality with another web-based application or client application using Web Services), proprietary applications that access system 100 through the internet, proprietary applications that extend existing third-party application with system 100 functionality, networks that access system 100 directly though dedicated point-to-point connections into system 100 data-centers (e.g., T1 service, etc), and or others.

The Client Layer 604 wraps any HTTP, HTML, JavaScript, or any other standard technology input from any access unit 104, and transmits it to the Presentation Layer 606 and Controller Layer 608. The information presented to these layers by the Client Layer 604 is separated into appropriate data streams (formats) and passed onto the Manager Layer 610. Using dynamic pages the layers 606 and 608 call and instantiate all the appropriate manager objects within layer 610, commensurate with the types of data streams being passed on to layer 610. The Presentation Layer 606 is comprised of code that uses the abstracted Controller Layer 608 code and wraps it in the appropriate GUI for the Client Layer 604. The Controller Layer 608 provides testable, reusable business logic that drives the Presentation Layer 606.

The preferred methods of providing system 100 of the present invention are either through a shared Application Service Provider Model (ASPM), or through a dedicated enterprise model. The ASPM shares hardware resources across multiple accounts and generally provides fully managed services. The enterprise model allows an account to have a dedicated hardware platform running system 100 for the specific purposes of that single account.

(a) Setting Accounts (ASPM)

In general, for ASPM, accounts with system 100 of the present invention may be set-up by any entity using the illustrated exemplary procedure 1100 in FIG. 11 through the appropriate access unit 104. Although illustrated as distinctive operations, some of the operations or acts and procedures may overlap. Additionally, the screens and order of the screens included in account creation 1100 may vary depending on the types of accounts created. For example, operations or acts 1102, 1104, 1106, and 1108 do not have to be completed in the specified order. As with any other account creation method, operations 1102 and 1104 require collection of information about the entity and its administrator when setting-up an account, and operation 1106 enables the entity to select the vertical to be applied to system 100. Operations 1108 and 1110 collect billing information and verify the collected information. For example, the billing might be through credit card at operation 1108, and at operation 1110, the system 100 verifies the authorization of the use and billing of that credit card. At operation 1112, once an account is created, the system 100 will direct the entity to a login GUI screen. The last operation 1114 is an optional account setup wizard that assists entities in branding account into their company's look and feel. This wizard also allows group and security configurations for each entity. It should be noted that any step for account creation might be automated using the account setup wizard, and not just branding, and group or security configurations.

(b) Summary Module 1200

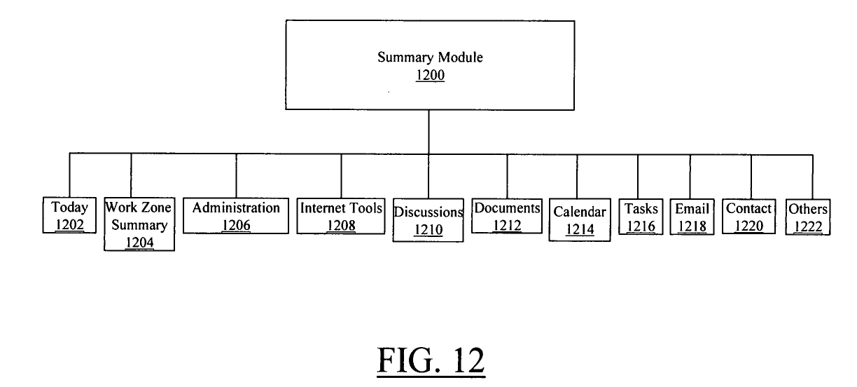

Upon setting up an account, users are provided access to system 100 of the present invention. As illustrated in FIG. 12, the member entities accessing their own account may be provided with a summary module 1200 that includes a variety of GUI frames that users may select to perform different functions. The summary module 1200 enables a user to view all work zones, and content therein. This view may be likened to a master view of the entire account that allows a user to have an overall view of all of the data stored within the work zones or across them at a glance. Within the general summary module 1200 is a frame 1202 intended to be used by the users when they first login after a long period away from the system 100. In general, a frame is user interface area or site. The frame 1202 may be comprised of reports over-viewing new and relevant items saved within the application and other content relevant to the users such as news, weather, stock quotes, etc. The work zone summary frame 1204 lists the various work zones created, including any new items (such as a newly received email) added thereto within each work zone. Within this work zone summary 1204, the users may view all their individual work zones 202, and select any displayed work zone within the work zone summary frame 1204 to be directed to the selected work zone.

The summary module 1200 further includes an administration frame 1206, comprised of the administration module with its own set of tools (described in detail below). The summary module 1200, along with the rest of the displays throughout the system 100 includes an Internet tool frame 1208 that contains a toolbox of web-based tools that are provided through web-services and by third-parties to load relevant content and functionality within the application. The summary module 1200 also allows users to view a summary of all data within each individual tool (application) across all work zones. For example, the discussion summary 1210 lists all the discussions across all work zones. The document summary 1212 lists all documents across all work zones, and the same holds true for calendar summary 1214, tasks summary 1216, Email summary 1218, contact summary 1220, or summary for any other vertical or horizontal object 1222. For example, the others summary frames 1222 within the summary module 1200 may contain the current work zone summary, this is a minimized summary display of the work zone currently open. In addition, most of the tools (applications) available within a work zone, are also available in the summary module 1200, and therefore may be used outside of the context of the work zone. The summary module 1200 will therefore allow users to view, create, edit or perform any function available to a user to an object (e.g., add an event to a calendar, forward an Email, enter a task, etc.) outside a work zone environment.

(c) Work Zone Module 1300

Each individual work zone 108 environment is comprised of graphic user interfaces (GUI) that divide into various frames that enables users to navigate through the work zone 108, and provides all the tools and data contained within the work zone 108. The first user interface (UI) frame 1302 within work zone module 1300 is used for access to a summary module 1200 and other work zones 108 listed therein. The first UI frame 1302 enables end users to select the summary icon to retrieve the summary module 1200 or select any of the created and saved work zones 108 listed to retrieve the work zones. The second UI frame 1304 within a typical work zone module 1300 may be used for access to tools 1306 and other functions 1308 to 1314 relevant to the current work zone module 1300. The other UI frame 1316 may be used for access to other functions such as Internet search functionality. Although not illustrated for clarity, it should be noted that all displays for all objects contain a tab (or some other GUI) exclusively dedicated to security. As was described above, the security system of the present invention is based on an object-based security, and hence every object will have associated with it a security tab or other security GUI to enable selection and setting of permissions or authorization for accessing (or levels of accessing) for that object, including work zone, summary, and other modules.

The second UI frame 1304 comprises of tools frame 1306 that enable an entity to manage collaboration objects between it and other entities. The second UI frame 1304 also comprises of information GUI 1308 relevant to the work zone 108 such as the date the work zone 108 was created, or the status of the project for which the work zone 108 was created. The users GUI 1310 is merely a listing of all members that were added to the work zone 108 by a work zone administrator. Any entity collaboratively involved with a project for which the work zone was created will appear on this list 1310. The options GUI 1312 represent the methods for settings and preferences of a current work zone 108, and the other optional GUI frame 1314 add other functionality to the work zone 108.

(d) Work Zone Tools 1306

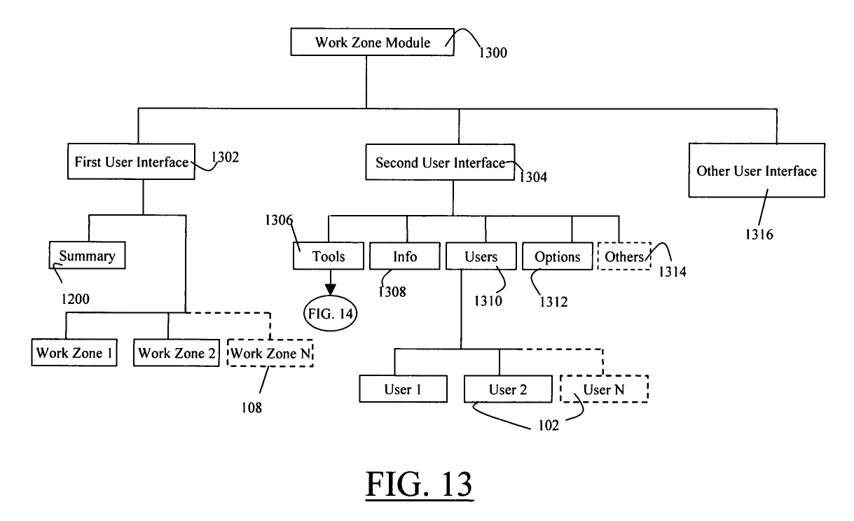

FIGS. 14-20 illustrates the details of the tool set 1306 of FIG. 13 available to users within a work zone 108. A few exemplary tools are illustrated in FIG. 14, that include, but should not be limited to, for example, discussions 1402, documents 1404, calendar 1406, tasks 1408, email 1410, contact manager 1412, others 1414, nonlimiting examples of which may include voice mail, fax, video conferencing, application sharing, shared whiteboard, voice conferencing, and instant messaging. Essentially, these are all individual applications within the work zone 108 of system 100. Hence, all tools and every object generated by them are kept in a single location related to a specific project. It could also be said that the tools are contained within the application and the objects created by the tools are saved in the context of a work zone 108.

The following paragraphs describe in greater detail each of the various exemplary tools 1306 in details.

(I) Discussion Manager 1402

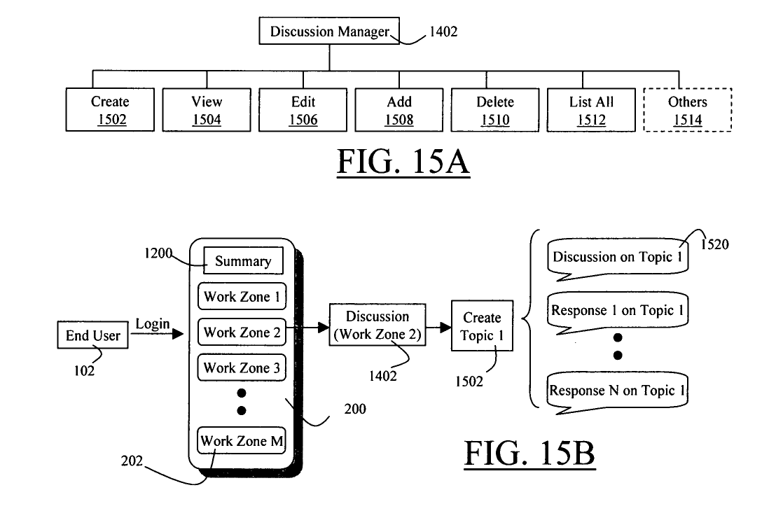

Discussion manager 1402 illustrated in FIG. 15A is used for exchange of ideas and information in a discussion forum. Discussion forums can keep a permanent history of conversations among users within a particular work zone 202 or group. This tool may be used for joint file editing, team projects, brainstorming, and other collaborative work that needs to record a conversation script or decision making process. Discussion forums allow a user to establish forums on any topic to generate feedback or new ideas from a group, post a suggestion or problem solution, or limit a discussion to a specified group of users or open participation to the entire organization. As part of the system 100 online collaboration suite, the discussion forum application is available from anywhere in the world using any network or Internet enabled technology. With Discussion Forums, project teams and departments can brainstorm ideas for proposals and procedures. Remote office employees can participate in discussions despite different time zones. Companies can collect employee suggestions on an ongoing basis.

The discussion manager 1402 may be likened to a news group or an on-line bulletin board. Creating new topics of discussion through the create screen 1502 is very much similar to the GUI format used for Emails. However, the discussions created have a more centralized nature where users can actually track the replies in a hierarchy. This cannot be done with Email applications. In addition, the discussions created and forwarded for posting is broadcast to all intended users, whereas email is a one-on-one or point-to-point exchange of information. Posting to a topic can be likened to replying to an email. The other features 1504 to 1514 of the discussion manager are GUI displays that enables the user to add 1508, edit 1506, view 1504, delete 1510, list all discussions 1512, or perform other related functions 1514.

Although illustrated as a separate module, it should be noted that the discussion manager 1402 is not a separate module or application of the present invention 100, but is an inherent part of every tool 1306 similar to security features within system 100. That is, the functionality of the discussion manager is inherent to any tool within any work zone 108. For example, as illustrated in FIG. 15B, within a work zone 108 an end user might have a document such as an invoice that the user wishes to initiate a discussion session 1520 with other entities 202. The system 100 of the present invention enables an end user 102 to create a discussion session 1502 about an individual object (such as the exemplary invoice) and spin off a discussion thread 1520 on it. With system 100 of the present invention every single object in a work zone 108 can have a threaded discussion created about the object. The discussions 1402 enables the creation of a fully threaded news group type of discussion system that can be tied to any individual objects in the system. When user selects an object (the exemplary invoice document) that has associated with it a threaded discussion 1520 (topic 1), the end user can see all the discussions about that selected object (the exemplary invoice document).

Therefore, the discussion sessions of the present invention is an object based threaded discussion system. That is, discussions become or are a part of the base functionality of a work zone, and therefore an integral part of every object created within the work zone 108. Every object, module, or application residing or existing within a work zone (and the work zone itself) will inherently, natively, without any additional work support threaded discussions. For example, an end user may select an event within the calendar module 1406 and spin-off a threaded discussion regarding a meeting on a particular date. Thereafter, when that event within the calendar module is later selected, all discussions associated with that event may be viewed by authorized users. As another example, user may receive an email within a work zone 108, and using the email module within that particular work zone the user may spin-off a threaded discussion about the email received. When at a later time that email is selected, all discussions associated with that email could be viewed by authorized users. As yet another example, a member may initiate a threaded discussion on the work zone itself, which relates to the entire project for which the work zone was created. Thereafter, all discussions about that work zone can be view by any authorized users.

As to the security, just as with any other object, discussions also have an object-based security. With discussions, security is set on the topic and not on the posts (messages) within the topic. This means that the creator of the topic enables visibility of a topic to certain individuals. Hence, only authorized individuals will be able to view the topic to begin discussion. The posted messages for that topic will be viewed by all that are authorized to view the topic. In comparison, the email security is set on every email message. One could conceptually think of the topic as an object, but from the backend standpoint, each individual entry is an object that has security rights.

(II) Document Module

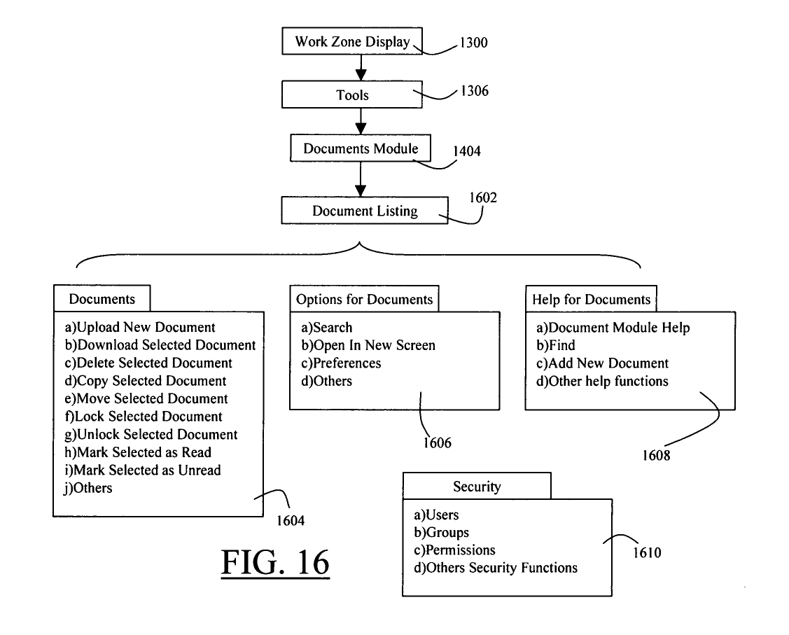

Documents module 1404 illustrated in FIG. 16 allows users to securely share documents, files and other content within an organization and with remote workers and business partners. This way, authorized users have secure access to important files at any time, from anywhere. The document module 1404 allows users to locate the latest version of a file or document, open a colleague's document for review, or retrieve the electronic version of a file from a branch office or home.

As part of the system 100 online collaboration suite, the document module 1404 is available from anywhere in the world using a simple web browser or other similar technology. With the document module 1404, project teams have access to the latest documents. The uploaded documents may also be published and posted. All documents may be uploaded using integrated upload functionality. The system 100 of the present invention may be used in combination with any standard operating system to transfer or move files or an entire folder structure. Any document may be uploaded, saved, and set permissions within system 100 of the present invention.

Upon selection of the document module GUI icon 1404 within the work zone 108, the members are provided with a listing 1602 of all the documents. In fact, the main navigation for the document module 1404 is though the document listing 1602. The document listing 1602 is the hub of the document module 1404, and its purpose is to allow users view and browse all documents in their current work zone 108. All documents within the document module are displayed in a folder structure similar to those found on most operating systems. All of the exemplary document manger functionality 1604 to 1608 are accessible through different GUIs, the non-limiting example of which may be a Menu Bar on the document listing display and or a short-cut GUI, such as short-cut buttons, or any other GUI format appropriate for representing the functions being sought by the user.

To access listing 1602, users may select the Document Module GUI 1404 within the tools loading frame 1306 of the work zone module 1300. As illustrated in FIG. 16, the exemplary functions 1604 to 1608 allow the users to navigate throughout the document list 1602. End users may upload, download, delete, view or perform many other functions, so long as they have appropriate permissions, rights, or authorization to do so. For example, if a user selects multiple documents to delete and does not have delete rights to some of the selected documents, a GUI will prompt and list which documents the user cannot delete. As with other standard software applications, when users do have the right to delete other documents, another GUI will prompt them to confirm if they indeed wish to delete the remaining documents. In addition, as done with most other standard applications, most of the items 1604(a)-1604(j), 1606(a) to 1606(d), and 1608(a) to 1608(d) when selected, will open (popup) a new GUI with many detailed information and or functionality related to that selected item.

Selecting the Upload New Document GUI 1604(a) will open the “Add Document” form (not illustrated) in a new GUI frame. The Add Document form itself is comprised of a GUI that allows the users to locate (browse for the document) and select the file they would like to upload to the system, and a second GUI to allow the users to specify the details related to any document (such as notes, security options, etc.).. More specifically, the process for uploading a document commences within a work zone 108 by selecting the document module 1404 GUI icon, and then selecting the upload document GUI icon within the application GUI 1604 of the document listing 1602. The rest of the processes are very similar to the standard operations used to upload a file as an attachment to an email message. Users with the necessary rights (authorization) on the document may view, edit, add, delete, or perform other functions such as enable versioning of documents. The user may also create a folder within a work zone 108 to organize the documents within that work zone.

The Download Selected document 1604(b) enables authorized users to select a document in the document list 1602 to download onto their access units 104. As described above, the Delete Selected document 1604(c) enables authorized users to delete selected documents, and the Copy Selected document GUI 1604(d) enables authorized users to copy a document on the list 1602. The selection of the Copy GUI 1604(d) opens a Document Copy-Move frame, which is used to copy or move documents from one work zone or folder to another. When authorized users select the Copy GUI within the Copy-Move frame, the selected displayed documents are copied to the selected work zone, and the Copy-Move frame GUI closes, and the user is returned to the Document List 1602. The selection of the Move Selected document GUI 1604(e) opens the same Copy-Move frame, but the authorized user selects the Move GUI within this frame instead of the Copy GUI to move the selected and displayed documents to the selected work zone or folders. As with Copy, the user is returned to the Document List 1602 once the Copy-Move frame closes.

The Lock Selected Document GUI 1604(f) enables authorized users to lock any selected document(s). Other users cannot download the current version of the document or upload a new version thereof if a document is locked. The Unlock Selected Document GUI 1604(g) enables authorized users to unlock any selected document. Other users can download the current version of the document or upload a new version thereof if a document is unlocked. It should be noted that to unlock a document, the user must be the person who initially locked it or have the override lock right. In addition, versioning settings on all documents within a work zone or account can be controlled by work zone-level and account-level settings. The Mark Selected as Read GUI 1604(h) enables an authorized user to mark the document as read, and the Mark Selected as Unread GUI 1604(i) marks the document as unread. Other functionality may include functions related to the specific types of documents within the document list 1602, such as images. The Options 1606 for the documents includes a Search GUI 1606(a) that enables authorized users to navigate to a search form within the document module context. Other functions 1606(b) to 1606(d), including all the Help functions 1608(a) to 1608(d) are standard functions employed by many standard software applications.

As with all other modules and objects within system 100, the security 1610 for document module 1404 and any objects therein is based on the above-described object-based security. In addition, for the document manger 1404, the system 100 of the present invention provides security features that prevent uploading of corrupt documents that may corrupt the entire system. The security features of any document within the document module 1404 may be set by a member that has the permission to upload the document, and the permission to set securities on an uploaded document. For example, the user may select multiple users 1610(a) and or multiple groups of users 1610(b) to enable them to only view a document. The user may allow several other users the option of editing or deleting a document or even editing the security settings for a particular document. Hence, for all objects within all the document module 1404, security 1610 may be set by selecting users 1610(a) and groups 1610(b) that the member wishes to associate with the document, and then selecting the specific permissions 1610(c) that the member would like for each added users and groups. The number and type of permissions that may be set on any document is large, the non-limiting, non-exhaustive examples of which may include, permissions to view, edit, delete, edit security, move, copy, lock, etc. In addition to the above object-based security, as with all other modules and objects within system 100, the threaded discussion (not illustrated in FIG. 16) for the document module 1404 and any objects therein is based on the above described object-based threaded discussion sessions.

(III) Calendar Module 1406

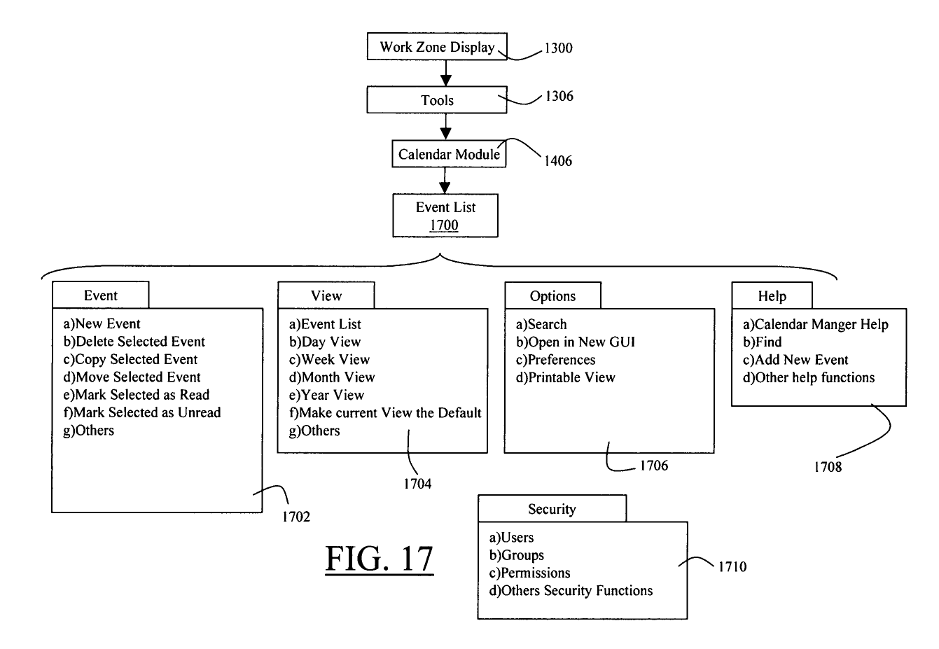

The online calendar module 1406 illustrated in FIG. 17 allow users to keep track of personal appointments, group meetings and any other events. The calendar module 1406 allows users to schedule recurring meetings and set reminders to notify participants by e-mail, attach relevant agendas or directions to a calendar event, sync user appointments with other systems external to system 100, such as PDAs or other mailing software system from anywhere at any time. As part of the system 100 collaboration suite, the calendar module 1406 is available from anywhere in the world using any network or internet enabled technologies. With the calendar module 1406, remote users can track the availability of other users. Project teams can access the latest deadline dates, or other departments of an organization can post quarterly meeting dates and share agendas.

Upon selection of the calendar module GUI icon 1406 within the work zone 108, the users are provided with a listing 1700 of all the events within the calendar module. The event list 1700 provides the navigation for the entire calendar module 1406. The event list 1700 displays every event in the system and allows the user to perform nearly all functions that pertain to events and the calendar, the non-limiting examples of which include viewing the calendar in various forms, changing the date and time of an event, or adding an event.

The event list 1700 is accessed by selecting the calendar link 1406 in the tool-loading frame 1306 of a work zone module 1300. All of the exemplary calendar module 1406 functionality illustrated in FIG. 17 are accessible through different GUIs, the non-limiting example of which may be Menu Bars on the event listing display 1700 and or short-cut GUI, such as short-cut buttons, or any other GUI format appropriate for representing the functions being sought by the user. As illustrated in FIG. 17, the exemplary functions 1702 to 1708 allow the users to navigate throughout the Event List 1700. Users may add, delete, view or perform many other functions, so long as they have appropriate permissions, rights, or authorization to do so. As with other standard software applications, most of the items 1702(a) to 1702(g), 1704(a) to 1704(g), 1706(a) to 1706(d), and 1708(a) to 1708(d) when selected, will open (popup) a new GUI with many detailed information and or functionality related to that selected item.

Selecting the New Event GUI 1702(a) will open the Event Form (not illustrated) in a new GUI frame. An event is any occurrence that takes place at a specified time, on a specific day or within a specific date (including within a day) range. For example, a company wide meeting on a certain day is an event. Authorized users may select the new event GUI 1702(a) to create (post) a new event within the calendar module 1406. The selection of new event GUI 1702(a) generates an event form (e.g. a web page) that enables the user to enter all relevant information with respect to the event of interest, or edit an existing event. The new event GUI 1702(a) enables users to set repeating options, which is essentially reoccurrence based on a pattern. For example, if a company wide meeting is held every third week of every month, the calendar module 1406, through the repeating option will remind the user about this meeting.

The Delete Selected Event 1702(b) enables only authorized users to delete a single or multiple set of events. The Delete Selected Event 1702(b) functions in a similar manner to the Delete Selected Document 1604(c). The Copy Selected Event 1702(c) enables authorized users to copy an event on the list 1700. The selection of the Copy GUI 1702(c) opens a Calendar Copy-Move frame, which is used to copy or move recorded events from one work zone or folder to another. When authorized users select the Copy GUI within the Copy-Move frame, the selected displayed events are copied to the selected work zone, and the Copy-Move frame GUI closes, and the user is returned to the Event List 1700. The selection of the Move Selected Event GUI 1702(d) opens the same Copy-Move frame, but the user selects the Move GUI within this frame instead of the Copy GUI to move the selected and displayed events to the selected work zone or folders. As with Copy, the end user is returned to the Calendar List 1700 once the Copy-Move frame closes. The Mark Selected as Read GUI 1702(e) enables an authorized user to mark the event as read, and the Mark Selected as Unread GUI 1702(f) marks the event as unread. Other functionality may include functions related to the specific types of events within the event list 1700.

The View 1704 for the events includes an Event List GUI 1704(a), which enables authorized users to return to the Event List display 1700. Each of the other functions is represented by a different GUI, such as the Day View GUI 1704(b), the Week View GUI 1704(c). When any of such GUIs are selected, the selection will provide the user with the ability to navigate to and view all events occurring on the selected date (for the day view) or date range for others. The Options 1706 for the events includes a Search GUI 1706(a) that enables authorized users to navigate to a search form within the calendar module context. Other functions 1706(b) to 1706(d), including all the Help functions 1708(a) to 1708(d) are standard functions employed by many standard software applications.

As with all other modules and objects within system 100, the security 1710 for calendar module 1406 and any objects therein is based on the above-described object-based security. The security features of any event within the calendar module 1406 may be set by a user that has the permission to create an event, and the permission to set securities on that event. For example, users can allow other users access to their calendar to view schedules or events, while maintaining the privacy of personal events. As with other objects, the user may for example select multiple users 1710(a) and or multiple groups of users 1710(b) to enable them to only view an event. The user may allow several other users the option of editing or deleting an event or even editing the security settings for a particular event. Hence, for all objects within all the calendar module 1406, security 1710 may be set by selecting users 1710(a) and groups 1710(b) that the user likes to associate with the event, and then selecting the specific permissions 1710(c) that the user would like for each added users and groups. The number and type of permissions that may be set on any event is large, the non-limiting, non-exhaustive examples of which may include, permissions to view, edit, delete, edit security, move, copy, lock, etc. In addition to the above object-based security, as with all other modules and objects within system 100, the threaded discussion (not illustrated in FIG. 17) for the calendar module 1406 and any objects therein is based on the above described object-based threaded discussion sessions.

(IV) Task Module 1408

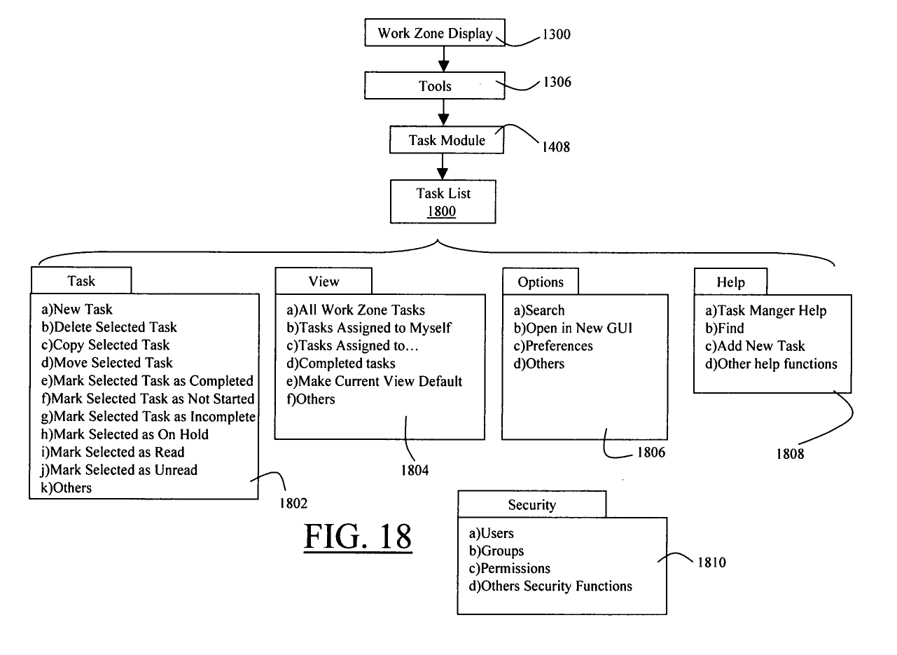

The task module 1408 illustrated in FIG. 18 enable users to keep track of personal action items, or delegate tasks to subordinates or members of a project team. Users can follow the progress of a task from start to completion, and can view status by owner, project or other criteria of choice. The task module 1408 allows users to monitor the status of tasks associated with various project work zones, assign permissions so that team members only see tasks that relate to their project work zones, or synchronize tasks with other devices external to system 100 such as PDAs. As part of the system 100 collaboration suite, the task module 1408 is available from anywhere in the world using a web browser. User can use the task module 1408 to manage projects and coordinate deliverables among all members of a department or project team or to track one's own action items tasks can be given dependencies that will allow them to be used to organize teams and projects for project management.

Upon selection of the task module GUI icon 1408 within the work zone 108, the users are provided with a listing 1800 of all the tasks within the task module. The task list 1800 provides the navigation for the entire task module 1408, and can display every task in the system and allows the user to perform nearly all functions that pertain to tasks, the non-limiting examples of which include changing the status of a task, marking a task as read, or adding a task.

The task list 1800 is accessed by selecting the task link 1408 in the tool-loading frame 1306 of a work zone module 1300. All of the exemplary task module 1408 functionality illustrated in FIG. 18 are accessible through different GUIs, the non-limiting example of which may be Menu Bars on the task listing display 1800 and or short-cut GUI, such as short-cut buttons, or any other GUI format appropriate for representing the functions being sought by the user. As illustrated in FIG. 18, the exemplary functions 1802 to 1808 allow the users to navigate throughout the task List 1800. Users may add, delete, view or perform many other functions, so long as they have appropriate permissions, rights, or authorization to do so. As with other standard software applications, most of the items 1802(a) to 1802(g), 1804(a) to 1804(g), 1806(a) to 1806(d), and 1808(a) to 1808(d) when selected, will open (popup) a new GUI with many detailed information and or functionality related to that selected item.

Selecting the new task GUI 1802(a) will open the Task Form (not illustrated) in a new GUI frame, where authorized users can create a new task or edit an existing one, and enter all relevant information with respect to a task. The Delete Selected Task 1802(b) enables only authorized users to delete a single set or multiple sets of tasks. The Delete Selected Task 1802(b) functions in a similar manner to the Delete Selected Document 1604(c). The Copy Selected Task 1802(c) enables authorized users to copy a task on the list 1800. The selection of the Copy GUI 1702(c) opens a task Copy-Move frame, which is used to copy or move recorded tasks from one work zone or folder to another. When users select the Copy GUI within the Copy-Move frame, the selected displayed tasks are copied to the selected work zone, and the Copy-Move frame GUI closes, and the end user is returned to the task list 1800. The selection of the Move Selected Task GUI 1802(d) opens the same Copy-Move frame, but the authorized user selects the Move GUI within this frame instead of the Copy GUI to move the selected and displayed tasks to the selected work zone or folders. As with Copy, the user is returned to the task List 1800 once the Copy-Move frame closes.

The Mark Selected Task as Completed 1802(e) enables users to mark and change the status of the selected task(s) to ‘completed.’ The Mark Selected Task as Not Started 1802(f) enables users to mark and change the status of the selected task(s) to ‘Not Started,’ and so on with the rest of the tools 1802(g) to 1802(j) that enable users to indicate and change the status of a task. The Mark Selected as Read GUI 1802(i) enables a user to mark the tasks as read, and the Mark Selected as Unread GUI 1802(j) marks the tasks as unread. Other functionality may include functions related to the specific types of tasks within the task list 1800.

The View 1804 for the tasks includes an All Work Zone Task GUI 1804(a), which enables users to return to the task list 1800. The Tasks Assigned to Myself GUI 1804(b) displays all tasks that have been assigned to the current user within the current work zone. The “Tasks Assigned To . . . ” GUI 1804(c) opens a new GUI frame containing the “View Tasks Assigned To” page. This page allows the users to choose whose assigned tasks they want to view. The Completed Tasks view GUI 1804(d) displays all completed task within the current filter (such as a current work zone, the summary view, and so on), and the Make Current View Default GUI 1804(e) sets preferences for the user. The current view is saved as the default view for the task list. The Options 1806 for the task includes a Search GUI 1806(a) that enables users to navigate to a search form within the task module context. Other functions 1806(b) to 1806(d), including all the Help functions 1808(a) to 1808(d) are standard functions employed by many standard software applications.

As with all other modules and objects within system 100, the security 1810 for task module 1408 and any objects therein is based on the above-described object-based security. The security features of any task within the task module 1408 may be set by a user that has the permission to create a task, and the permission to set securities on that task. As with other objects, the user may for example select multiple users 1810(a) and or multiple groups of users 1810(b) to enable them to only view a document. The user may allow several other members the option of editing or deleting a task or even editing the security settings for a particular task. Hence, for all objects within all the task module 1408, security 1810 may be set by selecting users 1810(a) and groups 1810(b) that the member likes to associate with a task, and then selecting the specific permissions 1810(c) that the member would like for each added users and groups. The number and type of permissions that may be set on any task is large, the non-limiting, non-exhaustive examples of which may include, permissions to view, edit, delete, edit security, move, copy, mark, etc. In addition to the above object-based security, as with all other modules and objects within system 100, the threaded discussion (not illustrated in FIG. 18) for the task module 1408 and any objects therein is based on the above described object-based threaded discussion sessions.

(V) Contact Module 1412

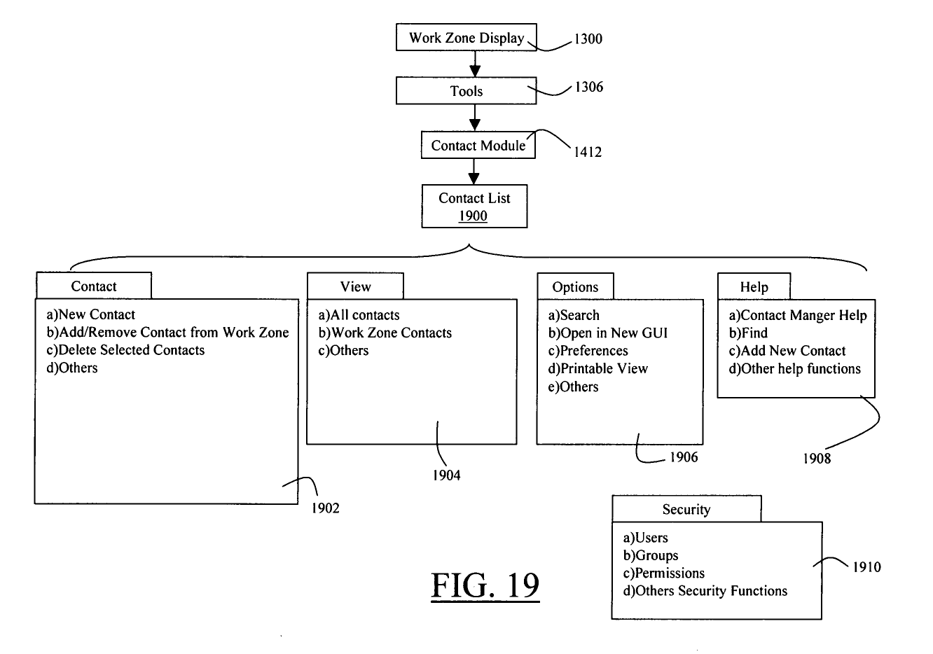

The contact module 1412 illustrated in FIG. 19 enables users to store all of their outside contacts and entity member information in the contact directories application. The contact directories application is designed to hold contact information for internal users of the system and external entities. The contact module 1412 allows users to list all of their system 100 members along with their job titles, photographs, phone and fax numbers, and e-mail and street addresses, or any other information relevant to contacts. In addition, the contact module 1412 stores all information about outside suppliers, clients, partners and other vendors, and grants access to member information for remote users so they can identify or reach other users. In addition, users can keep their outside contact information private or share it with others within an organization contact module 1412, just like all the other tools within system 100 may be synchronized with periphery devices that are external to system 100 such as PDAs. As part of the system 100 collaboration suite, the contact module 1412 is available from anywhere in the world using a web browser or similar technology. Contacts may be stored both as private contacts and as group-accessible entries. Remote workers can view a photo of someone in the home office. All contacts are created globally, but can be associated with a work zone 108 for easier access to relevant contact information. In addition, every single entry within the contact module is a security aware object, having object based security features like all other objects within the system 100. Most of the GUIs of any of the screen modules 1902 to 1908 for the contact module 1412 are similar to most GUIs used for industry standard contact software applications.

Upon selection of the contact module GUI icon 1412 within the work zone 108, the member are provided with a listing 1900 of all the contacts within the contact module. The contact list 1900 provides the navigation for the entire contact module 1412, and displays every contact in the system and allows the user to perform nearly all functions that pertain to contacts, the non-limiting examples of which include viewing, creating, and deleting contacts.

The contact list 1900 is accessed by selecting the contact link 1412 in the tool-loading frame 1306 of a work zone module 1300. All of the exemplary contact module 1412 functionality illustrated in FIG. 19 are accessible through different GUIs, the non-limiting example of which may be Menu Bars on the contact listing 1900 and or short-cut GUI, such as short-cut buttons, or any other GUI format appropriate for representing the functions being sought by the user. As illustrated in FIG. 19, the exemplary functions 1902 to 1908 allow the users to navigate throughout the contact List 1900. Users may add, delete, view or perform many other functions, so long as they have appropriate permissions, rights, or authorization to do so. As with other standard software applications, most of the items 1902(a) to 1902(d), 1904(a) to 1904(c), 1906(a) to 1906(e), and 1908(a) to 1908(d) when selected, will open (popup) a new GUI with many detailed information and or functionality related to that selected item.

Selecting the new Contact GUI 1902(a) will open the Contact Form (not illustrated) in a new GUI frame, where users can create a new contact or edit an existing one, and enter all relevant information with respect to a contact. The Add/Remove Contact from Work Zone GUI 1902(b) opens a contact work zone form in a new GUI frame. The contact work zone form allows users to associate existing contacts with a particular work zone. The Delete Selected Contacts GUI 1902(c) enables users to delete a single or multiple set of contacts. Upon selection of the Delete Selected Contacts GUI 1902(c), a new GUI frame opens that confirms that the user wants to delete the current selection. Other functionality may include functions related to the specific types of contacts within the contact list 1900.

The View 1904 for the contacts includes an All Contacts GUI 1904(a), which enables users to return to the contacts list 1900, and the Work Zone Contacts GUI 1904(b) displays all of the contacts within the current work zone in the contacts List. The Options 1906 for the contacts includes a Search GUI 1906(a) that enables authorized users to navigate to a search form within the contacts module context. Other functions 1906(b) to 1906(e), including all the Help functions 1908(a) to 1908(d) are standard functions employed by many standard software applications.

As with all other modules and objects within system 100, the security 1910 for contact module 1412 and any objects therein is based on the above-described object-based security. The security features of any contact within the contact module 1412 may be set by a user that has the permission to create a contact, and the permission to set securities on that contact. As with other objects, the members may for example select multiple users 1910(a) and or multiple groups of users 1910(b) to enable them to only view a contact. The members may allow several users the option of editing or deleting a contact or even editing the security settings for a particular contact. Hence, for all objects within all the contact module 1412, security 1910 may be set by selecting users 1910(a) and groups 1910(b) that the members likes to associate with the contact, and then selecting the specific permissions 1910(c) that the members would like for each added user and group. The number and type of permissions that may be set on any contact is large, the non-limiting, non-exhaustive examples of which may include, permissions to view, edit, delete, edit security, Add/Remove contact from work zone, etc. In addition to the above object-based security, as with all other modules and objects within system 100, the threaded discussion (not illustrated in FIG. 19) for the contact module 1412 and any objects therein is based on the above described object-based threaded discussion sessions. (VI) Email and Instant Messaging Modules Referring back to FIG. 14, the Email module 1410 and other tools 1414 within the work zone 108 such as instant messaging are tools that enable users to communicate with each other and entities outside the system 100. Instant messages allows users to initiate real-time conversations with any entity (within or external to system 100). System 100 of the present invention records scripts or transcripts of all instant message communications, and saves them within server 306. This allows users to keep a detailed log of all conversation with respect to any project within a work zone 108. Hence, a user within a work zone may instantiate an instant message session and automatically save it within that work zone. Instant messaging sessions can be instantiated and saved one of two ways. First, the session could be instantiated from a global user list and the system would prompt the user at the end of the session, requesting that the user select a work zone 108 to save the transcript. Second, the user could instantiate the session within the context of work zone 108, and at the end of the session, the transcript would be automatically saved to that work zone. The instant message sessions are saved and logged based on preferences, cannot be edited, and become a permanent record of that conversation—unless the work zone is deleted or a user with appropriate rights deletes the script. This is important from the compliance standards for various organizations. A system administrator may set limits as to which users may or may not have instant message sessions and with whom. Instant messaging is fully integrated into System 100 with work zone awareness. Policies can be set within System 100 making the storage of instant messaging dialogues either mandatory for compliance with various governmental regulations or optional in those instances where regulatory compliance is not an issue. Just as with all other tools 1306, all instant message objects are work zone aware, with security based on the object based security system, and include object-based threaded discussions.

The Email application 1410 is a full-featured web-based email program accessible from the user account. Each user is assigned a personalized email address that uses the entity's address within system 100. The Email application 1410 allows users to exchange email with anyone, and sends and receives email while doing other work. The emails may be sent or received within each work zone 108. As part of the system 100 online collaboration suite, the Email application 1410 is available from anywhere in the world using a web browser or other client applications such as a PDA, Pager, etc. As a system 100 administrator, a user can decide whether to enable the web-based Email application 1410 in an account or whether to use an existing email service. All authorized users of an email application 1410 of system 100 can create personal email accounts. Members of a work zone 100 (the users listed within a work zone) can prioritize project work zone—related email or separate it from general email.

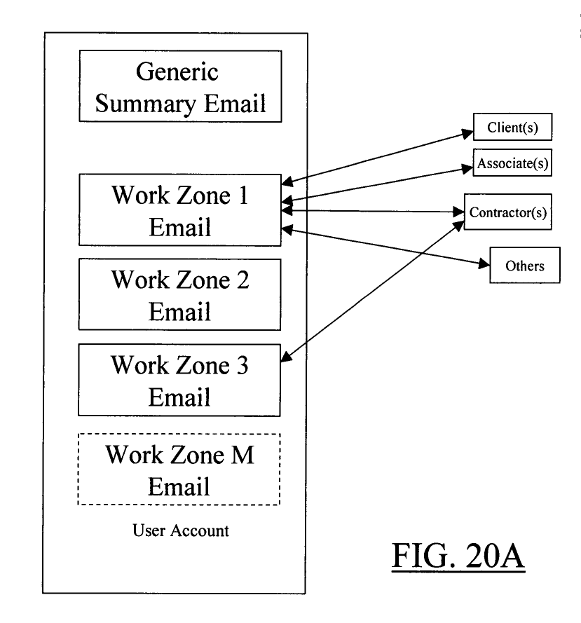

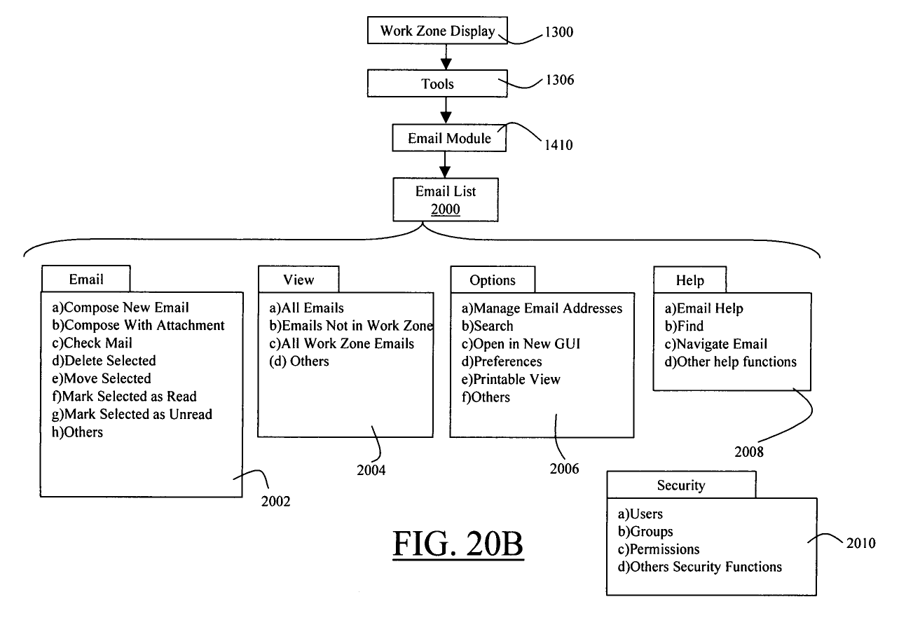

As illustrated in FIG. 20A, the system 100 of the present invention automates the process of sorting email. That is, all emails, like all other objects created within system 100 are work zone aware. The system 100 has an auto-sorting work zone aware “inbox” where incoming emails are directed to the specific work zones from which they were instantiated. A reply e-mail to an outgoing email initiated from work zone 3 will be directed automatically upon receipt to the “inbox” of work zone 3 making the email reply completely work zone aware. Users optionally can select other areas for reply emails to be automatically routed to include for example specific worksheets, task sheets and others. For convenience of the user, besides having a work zone specific email inbox and work zone specific email outbox, there is also an overall summary email inbox display and a summary email outbox display. These summary mail boxes will host all the incoming and outgoing emails from all the individual work zones and other locations that can be used as a quick reference in the review of the overall email traffic being sent and received by the user.

Upon selection of the Email module GUI icon 1410 within the work zone 108, the users are provided with a listing 2000 of all the email within the Email module. The Email list 2000 provides the navigation for the entire Email module 1410, and displays every Email in the system and allows the user to perform nearly all functions that pertain to Email, the non-limiting examples of which include viewing, sending, and deleting emails.

The Email list 2000 is accessed by selecting the Email link 1410 in the tool-loading frame 1306 of a work zone module 1300. All of the exemplary Email Module 1410 functionality illustrated in FIG. 20 are accessible through different GUIs, the non-limiting example of which may be Menu Bars on the Email listing display 2000 and or short-cut GUI, such as short-cut buttons, or any other GUI format appropriate for representing the functions being sought by the user. As illustrated in FIG. 20, the exemplary functions 2002 to 2008 allow the users to navigate throughout the Email List 2000. Users may send, delete, view or perform other functions, so long as they have appropriate permissions, rights, or authorization to do so. As with other standard software applications, most of the items 2002(a) to 2002(h), 2004(a) to 2004(d), 2006(a) to 2006(f), and 2008(a) to 2008(d) when selected, will open (popup) a new GUI with many detailed information and or functionality related to that selected item.

All Email functionality is similar to any standard email, except that all Email objects are work zone aware. For example, selecting the Compose New Email GUI 2002(a) will open the Email Form (not illustrated) in a new GUI frame, which is similar to any standard email with a text area to enter text, and so on. The Move selected Email GUI 2002(e) opens “Move Email” form in a new GUI frame, and allows the user to move the email to another work zone. Other functions illustrated are similar to standard email functions. The Other functionality 2002(h) may include functions related to the specific types of Emails within the Email list 2000.

The Email module also includes the View 2004, including the All Emails GUI 2004(a), which enables users to return to the Email List display 2000, which lists all emails (both in and out of work zones). The emails not in the Work Zone GUI 2004(b) displays all Emails that the user has received that are not filtered into a work zone. If the users are viewing the Email List 2000 within a specific work zone 108, view 2004 should be “All Work Zone Emails.”

The Options 2006 for the Email Module 1410 includes a Manage Email Address GUI 2006(a) that when selected opens an “Email Alias Manager” in a new GUI frame to enable management of new addresses. The Search GUI 2006(b) enables users to navigate to a search form within the Email module context. Other functions 2006(c) to 2006(f), including all the Help functions 2008(a) to 2008(d) are standard functions employed by many standard software applications.

As with all other modules and objects within system 100, the security 2010 for Email Manager module 1410 and any objects therein is based on the above-described object-based security. The security features of any Email within the Email module 1410 may be set by a member that has the permission to create an Email, and the permission to set securities on that Email. As with other objects, the member may for example select multiple users 2010(a) and or multiple groups of users 2010(b) to enable them to only view an Email. The member may allow several users the option of editing or deleting an Email or even editing the security settings for a particular Email. Hence, for all objects within the Email module 1410, security 2010 may be set by selecting users 2010(a) and groups 2010(b) that the member likes to associate with the Email, and then selecting the specific permissions 2010(c) that member would like for each added user and group. The number and type of permissions that may be set on any Email is large, the non-limiting, non-exhaustive examples of which may include, permissions to view, edit, delete, edit security, move, copy, mark, etc. In addition to the above object-based security, as with all other modules and objects within system 100, the threaded discussion (not illustrated in FIG. 20) for the Email module 1410 and any objects therein is based on the above described object-based threaded discussion sessions.

(VII) Administrative Module 1206

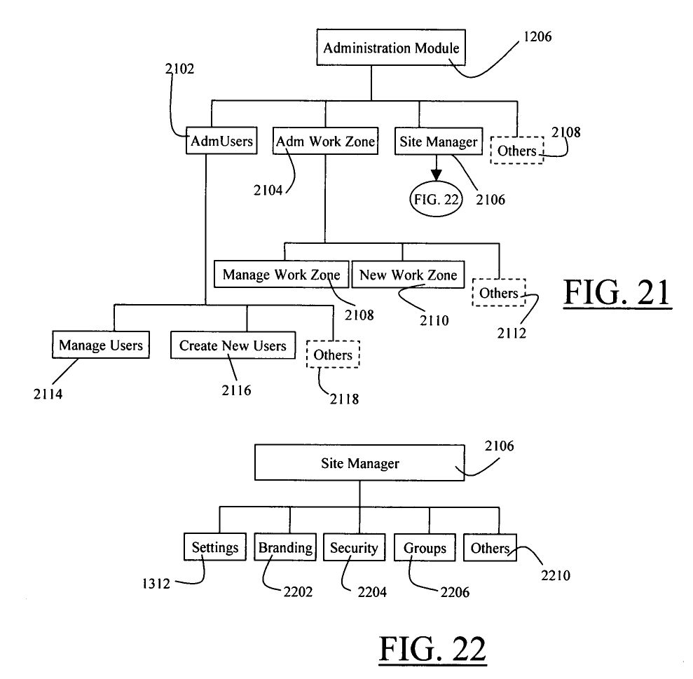

The administrative module 1206 illustrated in FIG. 12 provides all the administrative tools for the system 100 of the present invention, the details of which are disclosed in FIG. 21. The system 100 provides a set of tools to customize the look and feel, control access, and monitor usage of a user account through administrative module 1206. Through this module it also provides a wealth of customization and configuration options so users can easily integrate their web site with that of system 100 into their daily operations. Through sub-modules 2102, 2104, 2106, and 2108, administrative module 1206 allows users to customize their site's look and feel to match their company's identity, configure the layout of their home page by turning applications on or off, set permissions to limit access to specific content areas, and create member groups for efficient communication. Because the system 100 of the present invention collaboration suite is hosted online, all the administrative tools can be accessed from anywhere in the world using a browser through the client layer 604 (illustrated in FIG. 6). It should be understood that sub-modules 2102, 2104, 2106 and 2108 are not really sub-modules but are classifications for the different administrative functions.

The administrative module 1206 also enable users to determine the layout of any interface module within the system 100 and move features that users or a group most often use to the top of their home page. A company message and official logo may also be added (through Site Manager 2106). All of the interface elements throughout the application can be branded to match an organization's logo and identity. The administrator 1206 may also use the permission system to control access to specific areas of the site by users through modules 2106 and 2104, such as documents, and calendar events. These permission controls are used to provide only the necessary features and abilities within the system 100 to various users. Module 1206 can also create an extranet for companies that need to communicate securely with customers, or channel partners can use permission capabilities to allow guests access to all or part of the site. This module may also be used to set up remote workers and other members outside the physical location of the company. Selection of the Adm Users 2102 of the administrative module 1206 enables entities to manage 2114 or create new users 2116. From these two modules 2114 and 2116, users may be added to a group, assigned security, and contact information about the user may be added and modified. The Adm work zone 2104 enables the management 2108 or creation 2110 of work zones. The manage work zone module 2108 is available to users that have the authorization to alter work zones. Creation of work zone is based on the user's rights. The details for the various functions of site manager 2106 are described below in relation to the illustration in FIG. 22.

(VIII) Site Manager Module

The details of the site manager module 2106 of the administrative module 1206 (FIG. 21) are illustrated in FIG. 22. As illustrated, the site manager 2106 enables the user to change any settings or preferences 1312 with respect to any aspect of a user account. The branding 2202 enable users to customize system 100 for the look and feel of either a pre-existing web site or the company. All of system 100 can be modified to have the look and feel of the user entity with a seamless integration between the entity web site and system 100. System 100 can be accessed directly from a link on a company marketing web site. This allows a user to be redirected from a company web site to a login page that is automatically branded with the look and feel of the subscribing company. This way, the user's experience is not broken during the transition from the marketing site of the company to the system 100. System 100 also supports system-to-system communication, allowing users of one account to share selected information with users of a different account in a seamless manner allowing seamless Business to Business functionality.

System 100 also supports an offline version, which integrates seamlessly with the operating system through a desktop icon, integrates with an appropriate browser, and makes the system 100 appear as another drive on the system. This gives end-users the feeling that system 100 is an extension of their existing operating system. Additionally, this functionality allows users to interact with system 100 while disconnected from the network, the World Wide Web or the Internet. Information is replicated and/or synchronized with the system 100 servers 306 when the user reconnects to the their account. System 100 also supports templates that can be applied to new work zone, which allows a work zone to be created using existing best practices for internal process compliance, etc.

System 100 allows account administrators to designate a list of search parameters, keywords, and descriptions which are made available for crawling by various search engines as well as being actively published to certain search engines. Internet Search functionality is integrated into each display and font-end module applications within system 100. When a system 100 user conducts a search, the results and the sponsored search listings will be displayed within a display of the system 100. System 100 users that select a sponsor from the sponsored search listing will be directed to an advertiser's web-site outside of the system. Advertisers pay the search provider each time a user selects their listing from the sponsored listing. System 100 will share sponsored search revenue with the search provider.

System 100 also provides enhanced and effective web site Local Search capabilities of businesses, even for those vast numbers of businesses currently without web sites. In order to implement this Local Search capability, information on each business is obtained and/or transferred into a format (HTML or other compatible format) that is searchable by a variety of crawler software used by search engine companies and others. The information gathered can be included in the web site search results, such as is currently being handled by various established Internet search engines on basically a national level.

For the vast majority of small and medium businesses that do not currently have a web site, system 100 can easily accommodate an adequate database to provide for effective Local Search capabilities. System 100 can develop and host web sites (or web pages) for all business owners that may include, for example, the name of the business, phone numbers, address, zip code, description of the business, key words, map, etc. In order to obtain the information about the businesses, system 100 searches web sites or other resources on the web such as web-based yellow pages or other directories to populate a database and use other methods to obtain essential information about existing businesses. Additional information may be obtained through system 100 developing and hosting a free web site (or web page) to every potential business user. Each business can add their information to the system 100 web site whether they are system 100 subscribers or not. System 100 may display their page free (or with a minimal charge) to encourage non-current subscribing (or nonmember participants) businesses to subscribe to system 100 for various upgrades of available services. Each web page has an account sign-in screen and updateable field area for adding a more detailed description of the specific business operation by the business owner, that may be in HTML (or similar format), which exposes the business information to the search engines. Other methods may also be used to expose business information, so that a web surfer can easily find localized information about the business and other businesses within the Local Search results summary. For example, specific terms such as “pizza” can be searched in a local area using the Local Search capabilities having such search criteria as zip code, state, county, city, etc. The Local Search results, list both a hierarchy of listings within that local area on one side of the page and in the other side of the page specific area advertisers that are listed, those having the higher bids are placed on top advertisers listing. System 100 accounts enables users to bid for local hierarchy of advertising positions that allow them to move up on the advertisers on the Local Search results page.

Although the invention has been described in language specific to structural features and or methodological operations (or acts), it is to be understood that the invention defined in the appended claims is not necessarily limited to the specific features or operations described. Rather, the specific features and operations are disclosed as exemplary forms for implementing the claimed invention. Accordingly, while exemplary illustrative embodiments of the invention have been described, numerous variations and alternative embodiments will occur to those skilled in the art. For example, the system 100 could be implemented as client-centric, where most of the functionality resides on the client machine rather than a server-centric where most of the functionality resides on the server side. The system 100 may also be distributed via a traditional medium, such as on a CD or an enterprise edition, rather than the Application Service Provides Model described. In addition, system 100 may easily incorporate both vertical and horizontal content provider and content manager software application systems. Such variations and alternate embodiments are contemplated, and can be made without departing from the spirit and scope of the invention.

1. A method for collaboration, comprising the acts of:
providing a computer-implemented system that creates a single portal for entity members of said computer-implemented system to a set of software application tools, and that serves as a hub for collaboration amongst the entity members of said computer-implemented system;
said set of software application tools generating computer-implemented system objects, with said computer-implemented system objects providing:
a centralized space for a project that provides a work zone for maintaining information related to said project within said work zone;
an assembling of a distributed workgroup comprised of at least one entity member of said computer-implemented system into said work zone, thereby making said entity member of said computer-implemented system a work zone member, which unifies said work zone member and said project into said work zone to enable said work zone member and said entity member of said computer-implemented system to collaborate.

2. The method for collaboration as set forth in claim 1, wherein said work zone is a project specific environment that enables authorized access to said set of software application tools, and allows said set of software application tools to function collectively and collaboratively, specific to said project.

3. The method for collaboration as set forth in claim 2, wherein each said work zone for each said project has a complete set of software application tools.

4. The method for collaboration as set forth in claim 3, wherein said computer-implemented system sorts, organizes, and saves new and altered information of said work zone to said work zone.

5. The method for collaboration as set forth in claim 4, wherein said set of software application tools is comprised of front-end module applications and back-end core applications.

6. The method for collaboration as set forth in claim 5, wherein said front-end module applications and said back-end core applications are comprised of work zone aware vertical and horizontal software applications.

7. The method for collaboration as set forth in claim 6, wherein said front-end module applications are comprised of:
a thin client layer for accessing said computer-implemented system through an access units;
a presentation layer for abstracting data for said client layer; and
a controller layer that provides reusable business logic that drives said presentation layer.

8. The method for collaboration as set forth in claim 7, wherein said front-end module applications reside in said work zone, and are comprised of at least one of a discussion, summary, document, calendar, task, contact, instant messaging, and email module software application.

9. The method for collaboration as set forth in claim 8, wherein said work zone is comprised of a set of graphic user interface frames that are dedicated to said set of front-end module applications, and that when selected will initiate any one of said front-end module applications.

10. The method for collaboration as set forth in claim 9, wherein said discussion module software applications is comprised of an object-based discussion manager, which generates discussion object that are associated with said computer-implemented system objects to enable discussion forums about said computer-implemented system objects.

11. The method for collaboration as set forth in claim 10, wherein said object-based discussion manager is an inherent part of said computer-implemented system, providing an object-based threaded discussion forum functionality for any computer-implemented system object.

12. The method for collaboration as set forth in claim 11, wherein security for said object-based threaded discussions is based on object-based security set on a topic of discussion forum.

13. The method for collaboration as set forth in claim 12, wherein said summary module software application enables entity members of said computer-implemented system to have access to a summary of all data that are specific to an individual front-end module application, which span across all work zones.

14. The method for collaboration as set forth in claim 13, wherein said summary module software application enables said entity members of said computer-implemented system to generate front-end module application objects outside of a context of said work zone.

15. The method for collaboration as set forth in claim 14, wherein said document module software application enables entity members of said computer-implemented system to have access to documents, and includes security to prevent uploading of a corrupt document that may corrupt said computer-implemented system.

16. The method for collaboration as set forth in claim 15, wherein said calendar module software application enables entity members of said computer-implemented system to have access to calendar objects.

17. The method for collaboration as set forth in claim 16, wherein said task module software application enables entity members of said computer-implemented system to have access to task objects.

18. The method for collaboration as set forth in claim 17, wherein said contact module software application enables entity members of said computer-implemented system to have access to contact objects.

19. The method for collaboration as set forth in claim 18, wherein said contact module software application contains contact information for member entities and non-member entities.

20. The method for collaboration as set forth in claim 19, wherein said instant messaging module application enables entity members of said computer-implemented system to have access to instant messaging objects.

21. The method for collaboration as set forth in claim 20, wherein said instant messaging module software application is instantiated by said entity member of said computer-implemented system to commence an instant messaging session, and where said computer-implemented system saves said instant messaging session into a work zone selected by said entity member.

22. The method for collaboration as set forth in claim 21, wherein said instant messaging module application is instantiated by said work zone member within the context of a particular work zone to commence an instant messaging session, where said computer implemented system saves said instant messaging session into said particular work zone.

23. The method for collaboration as set forth in claim 22, wherein said electronic mail module software application enables entity members to have access electronic mail objects.

24. The method for collaboration as set forth in claim 23, wherein said work zone includes said electronic mail module software application with at least one work zone aware electronic mail inbox therein, and where incoming electronic mail are directed to said at least one work zone aware inbox.

25. The method for collaboration as set forth in claim 24, wherein said entity members are assigned a personalized electronic mail address.

26. The method for collaboration as set forth in claim 25, wherein said front-end module applications further includes at least an administration module application, wherein entity members are allowed access to functions related to administration of said computer-implemented system.

27. The method for collaboration as set forth in claim 26, wherein said administration module application further includes at least a site manager module application, wherein entity members are allowed access to functions related to site management of an entity member account.

28. The method for collaboration as set forth in claim 27, wherein said computer-implemented system supports an offline version of said set of software application tools that integrate with an operating system of said access unit for allowing entity members of said computer-implemented system to function offline.

29. The method for collaboration as set forth in claim 28, wherein information generated within said set of software application tools while offline, is replicated and synchronized with said computer-implemented system said entity members reconnect to entity member accounts.

30. The method for collaboration as set forth in claim 29, wherein said computer-implemented system provides Internet search functionality integral with said computer-implemented system.

31. The method for collaboration as set forth in claim 30, wherein entity members using said Internet search functionality are provided with results and a sponsored search listing, where upon selection of at least one sponsor from said sponsored search listing said entity members are directed to said selected sponsor advertisement web-site outside said computer-implemented system, and where said computer-implemented system is compensated by said selected sponsor for directing said entity member to said selected sponsor advertisement web-site.

32. The method for collaboration as set forth in claim 31, wherein said Internet search functionality provides both a local and a global search capability.

33. The method for collaboration as set forth in claim 32, wherein said local search capability provides search results with information that are local to a geographic area selected by said entity member.

34. The method for collaboration as set forth in claim 33, wherein said back-end core applications are comprised of a data, access, handler, and manager layers, and cross-layer subsystems that include a security subsystem and a utility subsystem.

35. The method for collaboration as set forth in claim 34, wherein said data layer is a portion of said back-end core applications that stores data for use by said computer-implemented system.

36. The method for collaboration as set forth in claim 35, wherein said data layer is comprised of a first component for sending, receiving, and storing messages, a second component for storing data, and a third component for storing files.

37. The method for collaboration as set forth in claim 36, wherein said second component is a relational database system for storing data, and said third component is a file storage system for storing data appropriately saved in file storage systems.

38. The method for collaboration as set forth in claim 37, wherein said relational database system is divided into two major sets of foundation and module tables, with said foundation tables including data related to infrastructure of said computer-implemented system and said module tables related to front-end module applications of said computer-implemented system.

39. The method for collaboration as set forth in claim 38, wherein said relational database system includes work zone identification data that relates said computer-implemented system objects to a particular work zone object, thereby making said computer-implemented system objects and any associated objects therewith work zone aware.

40. The method for collaboration as set forth in claim 39, wherein said access layer provides access layer objects for controlling access to said data layer, and base-functionality for use in other layers.

41. The method for collaboration as set forth in claim 40, wherein said access layer is comprised of a first component access for accessing said first component of said data layer, a database access component for accessing said database component of said data layer, a file access component for accessing said file storage component of said data layer, a security access component for accessing a security component of said data layer, and a logging access component for providing a mechanism for reporting errors.

42. The method for collaboration as set forth in claim 41, wherein said database access component of said access layer is comprised of initializer objects for resolving seemingly irresolvable conflicts, and destructor objects for handling processes of removing fundamental objects from said foundation tables of said data layer, and for providing a central method to store logic associated therewith.

43. The method for collaboration as set forth in claim 42, wherein said handler layer is comprised of handler objects that wrap functionality of said access layer objects, with each said handler layer object using said access layer objects to access a different component of said data layer.

44. The method for collaboration as set forth in claim 43, wherein said manager layer is comprised of manager layer objects that provide an interface used by said front-end module applications, and shield the rest of said back-end core applications from improper access.

45. The method for collaboration as set forth in claim 44, wherein all requests for connections to said data layer are generated by said manager layer objects, and passed onto said handler layer objects.

46. The method for collaboration as set forth in claim 45, wherein said security subsystem provides complete control over said entity members and all computer-implemented system objects, and provide both external and internal security to said computer-implemented system.

47. The method for collaboration as set forth in claim 46, wherein said external security controls public interface with said front-end module applications, and is comprised of:
an encryption security module for encrypting all communication between said access unit and said server computer to ensure privacy;
a threat detection module that monitors and detects transmissible threats overall all data transmissions; and
an intrusion detection module that does network monitoring to diminish the impact of intruders.

48. The method for collaboration as set forth in claim 47, wherein said internal security protect the data contained in said back-end core, and is comprised of:
an authentication module for authentication of entity members to access said computer-implemented system; and
a permission management module that facilitates an object-based security system for said computer-implemented system, where each said computer-implemented system object and entity member related to said computer-implemented system has the ability to have defined for said computer-implemented system object and said entity member individual user rights.

49. The method for collaboration as set forth in claim 48, wherein said object-based security system generates security objects, wherein association of said security object with said computer-implemented system objects enables authorized access to said computer-implemented system, and said computer-implemented system objects.

50. The method for collaboration as set forth in claim 49, wherein setting security on said computer-implemented system objects using said security objects automatically makes said computer-implemented system objects available to all entitled entity members of said computer-implemented system.

51. The method for collaboration as set forth in claim 50, wherein said association of said security objects with each computer-implemented system object is comprised of:
a) selecting entity members and groups of entity members to be associated with said computer-implemented system object; and
b) selecting a specific set of permissions for each of said selected entity members and groups of entity members to provide distinct, assign-able access rights to said computer-implemented system object;
whereby said security object enables authorization and a varied level of allowed access rights and privileges to said computer-implemented system object.

52. The method for collaboration as set forth in claim 51, wherein said object-based security system is an inherent part of said computer-implemented system, providing object-based security objects for any computer-implemented system objects.

53. The method for collaboration as set forth in claim 52, wherein every said computer-implemented system object is linked to one security object, and each said security object is linked to one computer-implemented system object.

54. The method for collaboration as set forth in claim 53, wherein a plurality of computer implemented system objects are linked to one said security object, sharing analogous authorizations.

55. The method for collaboration as set forth in claim 54, wherein each security object enables an entity member to define access rights for each computer-implemented system object.

56. The method for collaboration as set forth in claim 55, wherein said computer-implemented system is one of a Web, Internet, Intranet, and Extranet based systems.

57. The method for collaboration as set forth in claim 56, wherein said computer-implemented system enables an authorized entity member instant access to up-to-date project related information without a need for synchronization.

58. The method for collaboration as set forth in claim 57, wherein access to said computer-implemented system is through a single login into an account of said entity member.

59. The method for collaboration as set forth in claim 58, wherein said account set up for said computer-implemented system is comprised of:
collecting information about an entity;
selecting a vertical set of software application for said account by said entity;
collection of billing data, and verification of said collected data; and
redirection of said entity to access said account though said single login.

60. The method for collaboration as set forth in claim 59, wherein said computer-implemented system is comprised of at least one server computer, within which said set of software application tools reside.

61. The method for collaboration as set forth in claim 60, wherein said at least one server computer is accessed by said access unit through at least one of a secured and an unsecured communications protocols.

62. The method for collaboration as set forth in claim 1, wherein each said work zone for each said project has a complete set of software application tools.

63. The method for collaboration as set forth in claim 1, wherein said computer-implemented system sorts, organizes, and saves new and altered information of said work zone to said work zone.

64. The method for collaboration as set forth in claim 1, wherein said set of software application tools is comprised of front-end module applications and back-end core applications.

65. The method for collaboration as set forth in claim 64, wherein said front-end module applications and said back-end core applications are comprised of work zone aware vertical and horizontal software applications.

66. The method for collaboration as set forth in claim 64, wherein said front-end module applications are comprised of:
a thin client layer for accessing said computer-implemented system through an access units;
a presentation layer for abstracting data for said client layer; and
a controller layer that provides reusable business logic that drives said presentation layer.

67. The method for collaboration as set forth in claim 64, wherein said front-end module applications reside in said work zone, and are comprised of at least one of a discussion, summary, document, calendar, task, contact, instant messaging, and email module software application.

68. The method for collaboration as set forth in claim 1, wherein said work zone is comprised of a set of graphic user interface frames that are dedicated to said set of front-end module applications, and that when selected will initiate any one of said front-end module applications.

69. The method for collaboration as set forth in claim 64, wherein said front-end module applications are comprised of at least a discussion module software applications, which is comprised of an object-based discussion manager, which generates discussion object that are associated with said computer-implemented system objects to enable discussion forums about said computer-implemented system objects.

70. The method for collaboration as set forth in claim 69, wherein said object-based discussion manager is an inherent part of said computer-implemented system, providing an object-based threaded discussion forum functionality for any computer-implemented system object.

71. The method for collaboration as set forth in claim 69, wherein security for said object-based threaded discussions is based on object-based security set on a topic of discussion forum.

72. The method for collaboration as set forth in claim 64, wherein said end-end module applications are comprised of at least a summary module software application, which enables entity members of said computer-implemented system to have access to a summary of all data that are specific to an individual front-end module application, which span across all work zones.

73. The method for collaboration as set forth in claim 64, wherein said front-end module applications are comprised of at least a summary module software application, which enables said entity members of said computer-implemented system to generate front-end module application objects outside of a context of said work zone.

74. The method for collaboration as set forth in claim 64, wherein said front-end module applications are comprised of at least a document module software application, which enables entity members of said computer-implemented system to have access to documents, and includes security to prevent uploading of a corrupt document that may corrupt said computer-implemented system.

75. The method for collaboration as set forth in claim 64, wherein said front-end module applications are comprised of at least a calendar module software application, which enables entity members of said computer-implemented system to have access to calendar objects.

76. The method for collaboration as set forth in claim 64, wherein said front-end module applications are comprised of at least a task module software application that enables entity members of said computer-implemented system to have access to task objects.

77. The method for collaboration as set forth in claim 64, wherein said front-end module applications are comprised of at least a contact module software application that enables entity members of said computer-implemented system to have access to contact objects.

78. The method for collaboration as set forth in claim 77, wherein said contact module software application contains contact information for member entities and non-member entities.

79. The method for collaboration as set forth in claim 64, wherein said front-end module applications are comprised of at least an instant messaging module application that enables entity members of said computer-implemented system to have access to instant messaging objects.

80. The method for collaboration as set forth in claim 64, wherein said front-end module applications are comprised of at least an instant messaging module software application, which is instantiated by said entity member of said computer-implemented system to commence an instant messaging session, and where said computer-implemented system saves said instant messaging session into said work zone selected by said entity member.

81. The method for collaboration as set forth in claim 64, wherein said front-end module applications are comprised of at least an instant messaging module application, which is instantiated by said work zone member within the context of a particular work zone to commence an instant messaging session, where said computer implemented system saves said instant messaging session into said particular work zone.

82. The method for collaboration as set forth in claim 64, wherein said front-end module applications are comprised of at least an electronic mail module software application that enables entity members to have access electronic mail objects.

83. The method for collaboration as set forth in claim 1, wherein said work zone includes an electronic mail module software application with at least one work zone aware electronic mail inbox therein, and where incoming electronic mail are directed to said at least one work zone aware inbox.

84. The method for collaboration as set forth in claim 1, wherein said entity members are assigned a personalized electronic mail address.

85. The method for collaboration as set forth in claim 64, wherein said front-end module applications further includes at least an administration module application, wherein entity members are allowed access to functions related to administration of said computer-implemented system.

86. The method for collaboration as set forth in claim 85, wherein said administration module application further includes at least a site manager module application, wherein entity members are allowed access to functions related to site management of an entity member account.

87. The method for collaboration as set forth in claim 1, wherein said computer-implemented system supports an offline version of said set of software application tools that integrate with an operating system of said access unit for allowing entity members of said computer-implemented system to function offline.

88. The method for collaboration as set forth in claim 87, wherein information generated within said set of software application tools while offline, is replicated and synchronized with said computer-implemented system said entity members reconnect to entity member accounts.

89. The method for collaboration as set forth in claim 1, wherein said computer-implemented system provides Internet search functionality integral with said computer-implemented system.

90. The method for collaboration as set forth in claim 89, wherein entity members using said Internet search functionality are provided with results and a sponsored search listing, where upon selection of at least one sponsor from said sponsored search listing said entity members are directed to said selected sponsor advertisement web-site outside said computer-implemented system, and where said computer-implemented system is compensated by said selected sponsor for directing said entity member to said selected sponsor advertisement web-site.

91. The method for collaboration as set forth in claim 89, wherein said Internet search functionality provides both a local and a global search capability.

92. The method for collaboration as set forth in claim 91, wherein said local search capability provides search results with information that are local to a geographic area selected by said entity member.

93. The method for collaboration as set forth in claim 64, wherein said back-end core applications are comprised of a data, access, handler, and manager layers, and cross-layer subsystems that include a security subsystem and a utility subsystem.

94. The method for collaboration as set forth in claim 64, wherein said back-end core applications are comprised of at least a data layer, which is a portion of said back-end core applications that stores data for use by said computer-implemented system.

95. The method for collaboration as set forth in claim 94, wherein said data layer is comprised of a first component for sending, receiving, and storing messages, a second component for storing data, and a third component for storing files.

96. The method for collaboration as set forth in claim 95, wherein said second component is a relational database system for storing data, and said third component is a file storage system for storing data appropriately saved in file storage systems.

97. The method for collaboration as set forth in claim 96, wherein said relational database system is divided into two major sets of foundation and module tables, with said foundation tables including data related to infrastructure of said computer-implemented system and said module tables related to front-end module applications of said computer-implemented system.

98. The method for collaboration as set forth in claim 96, wherein said relational database system includes work zone identification data that relates said computer-implemented system objects to a particular work zone object, thereby making said computer-implemented system objects and any associated objects therewith work zone aware.

99. The method for collaboration as set forth in claim 93, wherein said access layer provides access layer objects for controlling access to said data layer, and base-functionality for use in other layers.

100. The method for collaboration as set forth in claim 93, wherein said access layer is comprised of a first component access for accessing said first component of said data layer, a database access component for accessing said database component of said data layer, a file access component for accessing said file storage component of said data layer, a security access component for accessing a security component of said data layer, and a logging access component for providing a mechanism for reporting errors.

101. The method for collaboration as set forth in claim 100, wherein said database access component of said access layer is comprised of initializer objects for resolving seemingly irresolvable conflicts, and destructor objects for handling processes of removing fundamental objects from said foundation tables of said data layer, and for providing a central method to store logic associated therewith.

102. The method for collaboration as set forth in claim 93, wherein said handler layer is comprised of handler objects that wrap functionality of said access layer objects, with each said handler layer object using said access layer objects to access a different component of said data layer.

103. The method for collaboration as set forth in claim 93, wherein said manager layer is comprised of manager layer objects that provide an interface used by said front-end module applications, and shield the rest of said back-end core applications from improper access.

104. The method for collaboration as set forth in claim 103, wherein all requests for connections to said data layer are generated by said manager layer objects, and passed onto said handler layer objects.

105. The method for collaboration as set forth in claim 93, wherein said security subsystem provides complete control over said entity members and all computer-implemented system objects, and provide both external and internal security to said computer-implemented system.

106. The method for collaboration as set forth in claim 105, wherein said external security controls public interface with said front-end module applications, and is comprised of:
an encryption security module for encrypting all communication between said access unit and said server computer to ensure privacy;
a threat detection module that monitors and detects transmissible threats overall all data transmissions; and
an intrusion detection module that does network monitoring to diminish the impact of intruders.

107. The method for collaboration as set forth in claim 105, wherein said internal security protect the data contained in said back-end core, and is comprised of:
an authentication module for authentication of entity members to access said computer-implemented system; and
a permission management module that facilitates an object-based security system for said computer-implemented system, where each said computer-implemented system object and entity member related to said computer-implemented system has the ability to have defined for said computer-implemented system object and said entity member individual user rights.

108. The method for collaboration as set forth in claim 107, wherein said object-based security system generates security objects, wherein association of said security object with said computer-implemented system objects enables authorized access to said computer-implemented system, and said computer-implemented system objects.

109. The method for collaboration as-set forth in claim 107, wherein setting security on said computer-implemented system objects using said security objects automatically makes said computer-implemented system objects available to all entitled entity members of said computer-implemented system.

110. The method for collaboration as set forth in claim 107, wherein said association of said security objects with each computer-implemented system object is comprised of:
a) selecting entity members and groups of entity members to be associated with said computer-implemented system object; and
b) selecting a specific set of permissions for each of said selected entity members and groups of entity members to provide distinct, assign-able access rights to said computer-implemented system object;
whereby said security object enables authorization and a varied level of allowed access rights and privileges to said computer-implemented system object.

111. The method for collaboration as set forth in claim 107, wherein said object-based security system is an inherent part of said computer-implemented system, providing object-based security objects for any computer-implemented system objects.

112. The method for collaboration as set forth in claim 107, wherein every said computer-implemented system object is linked to one security object, and each said security object is linked to one computer-implemented system object.

113. The method for collaboration as set forth in claim 107, wherein a plurality of computer implemented system objects are linked to one said security object, sharing analogous authorizations.

114. The method for collaboration as set forth in claim 107, wherein each security object enables an entity member to define access rights for each computer-implemented system object.

115. The method for collaboration as set forth in claim 1, wherein said computer-implemented system is one of a Web, Internet, Intranet, and Extranet based systems.

116. The method for collaboration as set forth in claim 115, wherein said computer-implemented system enables an authorized entity member instant access to up-to-date project related information without a need for synchronization.

117. The method for collaboration as set forth in claim 1, wherein access to said computer-implemented system is through a single login into an account of said entity member.

118. The method for collaboration as set forth in claim 117, wherein said account set up for said computer-implemented system is comprised of:
collecting information about an entity;
selecting a vertical set of software application for said account by said entity;
collection of billing data, and verification of said collected data; and
redirection of said entity to access said account though said single login.

119. The method for collaboration as set forth in claim 1, wherein said computer-implemented system is comprised of at least one server computer, within which said set of software application tools reside.

120. The method for collaboration as set forth in claim 119, wherein said at least one server computer is accessed by said access unit through at least one of a secured and an unsecured communications protocols.

121. A computer program product for collaboration, the computer program product comprising a computer-readable medium having computer program instructions stored therein for causing a computer to perform operations of:
providing a computer-implemented system that creates a single portal for entity members of said computer-implemented system to a set of software application tools, and that serves as a hub for collaboration amongst the entity members of said computer-implemented system;
said set of software application tools generating computer-implemented system objects, with said computer-implemented system objects providing:
a centralized space for a project that provides a work zone for maintaining information related to said project within said work zone;
an assembling of a distributed workgroup comprised of at least one entity member of said computer-implemented system into said work zone, thereby making said entity member of said computer-implemented system a work zone member, which unifies said work zone member and said project into said work zone to enable said work zone member and said entity member of said computer-implemented system to collaborate.

122. The computer program product for collaboration as set forth in claim 121, wherein said work zone is a project specific environment that enables authorized access to said set of software application tools, and allows said set of software application tools to function collectively and collaboratively, specific to said project.

123. The computer program product for collaboration as set forth in claim 121, wherein each said work zone for each said project has a complete set of software application tools.

124. The computer program product for collaboration as set forth in claim 121, wherein said computer-implemented system sorts, organizes, and saves new and altered information of said work zone to said work zone.

125. The computer program product for collaboration as set forth in claim 121, wherein said set of software application tools is comprised of front-end module applications and back-end core applications.

126. The computer program product for collaboration as set forth in claim 125, wherein said front-end module applications and said back-end core applications are comprised of work zone aware vertical and horizontal software applications.

127. The computer program product for collaboration as set forth in claim 125, wherein said front-end module applications are comprised of:
a thin client layer for accessing said computer-implemented system through an access units;
a presentation layer for abstracting data for said client layer; and
a controller layer that provides reusable business logic that drives said presentation layer.

128. The computer program product for collaboration as set forth in claim 125, wherein said front-end module applications reside in said work zone, and are comprised of at least one of a discussion, summary, document, calendar, task, contact, instant messaging, and email module software application.

129. The computer program product for collaboration as set forth in claim 121, wherein said work zone is comprised of a set of graphic user interface frames that are dedicated to said set of front-end module applications, and that when selected will initiate any one of said front-end module applications.

130. The computer program product for collaboration as set forth in claim 125, wherein said front-end module applications are comprised of at least a discussion module software applications, which is comprised of an object-based discussion manager, which generates discussion object that are associated with said computer-implemented system objects to enable discussion forums about said computer-implemented system objects.

131. The computer program product for collaboration as set forth in claim 130, wherein said object-based discussion manager is an inherent part of said computer-implemented system, providing an object-based threaded discussion forum functionality for any computer-implemented system object.

132. The computer program product for collaboration as set forth in claim 130, wherein security for said object-based threaded discussions is based on object-based security set on a topic of discussion forum.

133. The computer program product for collaboration as set forth in claim 125, wherein said front-end module applications are comprised of at least a summary module software application, which enables entity members of said computer-implemented system to have access to a summary of all data that are specific to an individual front-end module application, which span across all work zones.

134. The computer program product for collaboration as set forth in claim 125, wherein said front-end module applications are comprised of at least a summary module software application, which enables said entity members of said computer-implemented system to generate front-end module application objects outside of a context of said work zone.

135. The computer program product for collaboration as set forth in claim 125, wherein said front-end module applications are comprised of at least a document module software application, which enables entity members of said computer-implemented system to have access to documents, and includes security to prevent uploading of a corrupt document that may corrupt said computer-implemented system.

136. The computer program product for collaboration as set forth in claim 125, wherein said front-end module applications are comprised of at least a calendar module software application, which enables entity members of said computer-implemented system to have access to calendar objects.

137. The computer program product for collaboration as set forth in claim 125, wherein said front-end module applications are comprised of at least a task module software application that enables entity members of said computer-implemented system to have access to task objects.

138. The computer program product for collaboration as set forth in claim 125, wherein said front-end module applications are comprised of at least a contact module software application that enables entity members of said computer-implemented system to have access to contact objects.

139. The computer program product for collaboration as set forth in claim 138, wherein said contact module software application contains contact information for member entities and non-member entities.

140. The computer program product for collaboration as set forth in claim 125, wherein said front-end module applications are comprised of at least an instant messaging module application that enables entity members of said computer-implemented system to have access to instant messaging objects.

141. The computer program product for collaboration as set forth in claim 125, wherein said front-end module applications are comprised of at least an instant messaging module software application, which is instantiated by said entity member of said computer-implemented system to commence an instant messaging session, and where said computer-implemented system saves said instant messaging session into said work zone selected by said entity member.

142. The computer program product for collaboration as set forth in claim 125, wherein said front-end module applications are comprised of at least an instant messaging module application, which is instantiated by said work zone member within the context of a particular work zone to commence an instant messaging session, where said computer implemented system saves said instant messaging session into said particular work zone.

143. The computer program product for collaboration as set forth in claim 125, wherein said front-end module applications are comprised of at least an electronic mail module software application that enables entity members to have access electronic mail objects.

144. The computer program product for collaboration as set forth in claim 121, wherein said work zone includes an electronic mail module software application with at least one work zone aware electronic mail inbox therein, and where incoming electronic mail are directed to said at least one work zone aware inbox.

145. The computer program product for collaboration as set forth in claim 121, wherein said entity members are assigned a personalized electronic mail address.

146. The computer program product for collaboration as set forth in claim 125, wherein said front-end module applications further includes at least an administration module application, wherein entity members are allowed access to functions related to administration of said computer-implemented system.

147. The computer program product for collaboration as set forth in claim 146, wherein said administration module application further includes at least a site manager module application, wherein entity members are allowed access to functions related to site management of an entity member account.

148. The computer program product for collaboration as set forth in claim 121, wherein said computer-implemented system supports an offline version of said set of software application tools that integrate with an operating system of said access unit for allowing entity members of said computer-implemented system to function offline.

149. The computer program product for collaboration as set forth in claim 148, wherein information generated within said set of software application tools while offline, is replicated and synchronized with said computer-implemented system said entity members reconnect to entity member accounts.

150. The computer program product for collaboration as set forth in claim 121, wherein said computer-implemented system provides Internet search functionality integral with said computer-implemented system.

151. The computer program product for collaboration as set forth in claim 150, wherein entity members using said Internet search functionality are provided with results and a sponsored search listing, where upon selection of at least one sponsor from said sponsored search listing said entity members are directed to said selected sponsor advertisement web-site outside said computer-implemented system, and where said computer-implemented system is compensated by said selected sponsor for directing said entity member to said selected sponsor advertisement web-site.

152. The computer program product for collaboration as set forth in claim 150, wherein said Internet search functionality provides both a local and a global search capability.

153. The computer program product for collaboration as set forth in claim 152, wherein said local search capability provides search results with information that are local to a geographic area selected by said entity member.

154. The computer program product for collaboration as set forth in claim 125, wherein said back-end core applications are comprised of a data, access, handler, and manager layers, and cross-layer subsystems that include a security subsystem and a utility subsystem.

155. The computer program product for collaboration as set forth in claim 125, wherein said back-end core applications are comprised of at least a data layer, which is a portion of said back-end core applications that stores data for use by said computer-implemented system.

156. The computer program product for collaboration as set forth in claim 155, wherein said data layer is comprised of a first component for sending, receiving, and storing messages, a second component for storing data, and a third component for storing files.

157. The computer program product for collaboration as set forth in claim 156, wherein said second component is a relational database system for storing data, and said third component is a file storage system for storing data appropriately saved in file storage systems.

158. The computer program product for collaboration as set forth in claim 157, wherein said relational database system is divided into two major sets of foundation and module tables, with said foundation tables including data related to infrastructure of said computer-implemented system and said module tables related to front-end module applications of said computer-implemented system.

159. The computer program product for collaboration as set forth in claim 157, wherein said relational database system includes work zone identification data that relates said computer-implemented system objects to a particular work zone object, thereby making said computer-implemented system objects and any associated objects therewith work zone aware.

160. The computer program product for collaboration as set forth in claim 154, wherein said access layer provides access layer objects for controlling access to said data layer, and base-functionality for use in other layers.

161. The computer program product for collaboration as set forth in claim 154, wherein said access layer is comprised of a first component access for accessing said first component of said data layer, a database access component for accessing said database component of said data layer, a file access component for accessing said file storage component of said data layer, a security access component for accessing a security component of said data layer, and a logging access component for providing a mechanism for reporting errors.

162. The computer program product for collaboration as set forth in claim 161, wherein said database access component of said access layer is comprised of initializer objects for resolving seemingly irresolvable conflicts, and destructor objects for handling processes of removing fundamental objects from said foundation tables of said data layer, and for providing a central method to store logic associated therewith.

163. The computer program product for collaboration as set forth in claim 154, wherein said handler layer is comprised of handler objects that wrap functionality of said access layer objects, with each said handler layer object using said access layer objects to access a different component of said data layer.

164. The computer program product for collaboration as set forth in claim 154, wherein said manager layer is comprised of manager layer objects that provide an interface used by said front-end module applications, and shield the rest of said back-end core applications from improper access.

165. The computer program product for collaboration as set forth in claim 164, wherein all requests for connections to said data layer are generated by said manager layer objects, and passed onto said handler layer objects.

166. The computer program product for collaboration as set forth in claim 154, wherein said security subsystem provides complete control over said entity members and all computer-implemented system objects, and provide both external and internal security to said computer-implemented system.

167. The computer program product for collaboration as set forth in claim 166, wherein said external security controls public interface with said front-end module applications, and is comprised of:
an encryption security module for encrypting all communication between said access unit and said server computer to ensure privacy;
a threat detection module that monitors and detects transmissible threats overall all data transmissions; and
an intrusion detection module that does network monitoring to diminish the impact of intruders.

168. The computer program product for collaboration as set forth in claim 166, wherein said internal security protect the data contained in said back-end core, and is comprised of:
an authentication module for authentication of entity members to access said computer-implemented system; and
a permission management module that facilitates an object-based security system for said computer-implemented system, where each said computer-implemented system object and entity member related to said computer-implemented system has the ability to have defined for said computer-implemented system object and said entity member individual user rights.

169. The computer program product for collaboration as set forth in claim 168, wherein said object-based security system generates security objects, wherein association of said security object with said computer-implemented system objects enables authorized access to said computer-implemented system, and said computer-implemented system objects.

170. The computer program product for collaboration as set forth in claim 168, wherein setting security on said computer-implemented system objects using said security objects automatically makes said computer-implemented system objects available to all entitled entity members of said computer-implemented system.

171. The computer program product for collaboration as set forth in claim 168, wherein said association of said security objects with each computer-implemented system object is comprised of:
a) selecting entity members and groups of entity members to be associated with said computer-implemented system object; and
b) selecting a specific set of permissions for each of said selected entity members and groups of entity members to provide distinct, assign-able access rights to said computer-implemented system object;
whereby said security object enables authorization and a varied level of allowed access rights and privileges to said computer-implemented system object.

172. The computer program product for collaboration as set forth in claim 168, wherein said object-based security system is an inherent part of said computer-implemented system, providing object-based security objects for any computer-implemented system objects.

173. The computer program product for collaboration as set forth in claim 168, wherein every said computer-implemented system object is linked to one security object, and each said security object is linked to one computer-implemented-system object.

174. The computer program product for collaboration as set forth in claim 168, wherein a plurality of computer implemented system objects are linked to one said security object, sharing analogous authorizations.

175. The computer program product for collaboration as set forth in claim 168, wherein each security object enables an entity member to define access rights for each computer-implemented system object.

176. The computer program product for collaboration as set forth in claim 121, wherein said computer-implemented system is one of a Web, Internet, Intranet, and Extranet based systems.

177. The computer program product for collaboration as set forth in claim 176, wherein said computer-implemented system enables an authorized entity member instant access to up-to-date project related information without a need for synchronization.

178. The computer program product for collaboration as set forth in claim 121, wherein access to said computer-implemented system is through a single login into an account of said entity member.

179. The computer program product for collaboration as set forth in claim 178, wherein said account set up for said computer-implemented system is comprised of:
collecting information about an entity;
selecting a vertical set of software application for said account by said entity;
collection of billing data, and verification of said collected data; and
redirection of said entity to access said account though said single login.

180. The computer program product for collaboration as set forth in claim 121, wherein said computer-implemented system is comprised of at least one server computer, within which said set of software application tools reside.

181. The computer program product for collaboration as set forth in claim 180, wherein said at least one server computer is accessed by said access unit through at least one of a secured and an unsecured communications protocols.

182. A computer-implemented system for collaboration, comprising:
a single portal for entity members of said computer-implemented system to a set of software application tools that serves as a hub for collaboration amongst the entity members of said computer-implemented system;
said set of software application tools generating computer-implemented system objects, with said computer-implemented system objects providing:
a centralized space for a project that provides a work zone for maintaining information related to said project within said work zone;
an assembling of a distributed workgroup comprised of at least one entity member of said computer-implemented system into said work zone, thereby making said entity member of said computer-implemented system a work zone member, which unifies said work zone member and said project into said work zone to enable said work zone member and said entity member of said computer-implemented system to collaborate.

183. The computer-implemented system for collaboration as set forth in claim 182, wherein said work zone is a project specific environment that enables authorized access to said set of software application tools, and allows said set of software application tools to function collectively and collaboratively, specific to said project.

184. The computer-implemented system for collaboration as set forth in claim 182, wherein each said work zone for each said project has a complete set of software application tools.

185. The computer-implemented system for collaboration as set forth in claim 182, wherein said computer-implemented system sorts, organizes, and saves new and altered information of said work zone to said work zone.

186. The computer-implemented system for collaboration as set forth in claim 182, wherein said set of software application tools is comprised of front-end module applications and back-end core applications.

187. The computer-implemented system for collaboration as set forth in claim 186, wherein said front-end module applications and said back-end core applications are comprised of work zone aware vertical and horizontal software applications.

188. The computer-implemented system for collaboration as set forth in claim 186, wherein said front-end module applications are comprised of:
a thin client layer for accessing said computer-implemented system through an access units;
a presentation layer for abstracting data for said client layer; and
a controller layer that provides reusable business logic that drives said presentation layer.

189. The computer-implemented system for collaboration as set forth in claim 186, wherein said front-end module applications reside in said work zone, and are comprised of at least one of a discussion, summary, document, calendar, task, contact, instant messaging, and email module software application.

190. The computer-implemented system for collaboration as set forth in claim 182, wherein said work zone is comprised of a set of graphic user interface frames that are dedicated to said set of front-end module applications, and that when selected will initiate any one of said front-end module applications.

191. The computer-implemented system for collaboration as set forth in claim 186, wherein said front-end module applications are comprised of at least a discussion module software applications, which is comprised of an object-based discussion manager, which generates discussion object that are associated with said computer-implemented system objects to enable discussion forums about said computer-implemented system objects.

192. The computer-implemented system for collaboration as set forth in claim 191, wherein said object-based discussion manager is an inherent part of said computer-implemented system, providing an object-based threaded discussion forum functionality for any computer-implemented system object.

193. The computer-implemented system for collaboration as set forth in claim 191, wherein security for said object-based threaded discussions is based on object-based security set on a topic of discussion forum.

194. The computer-implemented system for collaboration as set forth in claim 186, wherein said front-end module applications are comprised of at least a summary module software application, which enables entity members of said computer-implemented system to have access to a summary of all data that are specific to an individual front-end module application, which span across all work zones.

195. The computer-implemented system for collaboration as set forth in claim 186, wherein said front-end module applications are comprised of at least a summary module software application, which enables said entity members of said computer-implemented system to generate front-end module application objects outside of a context of said work zone.

196. The computer-implemented system for collaboration as set forth in claim 186, wherein said front-end module applications are comprised of at least a document module software application, which enables entity members of said computer-implemented system to have access to documents, and includes security to prevent uploading of a corrupt document that may corrupt said computer-implemented system.

197. The computer-implemented system for collaboration as set forth in claim 186, wherein said front-end module applications are comprised of at least a calendar module software application, which enables entity members of said computer-implemented system to have access to calendar objects.

198. The computer-implemented system for collaboration as set forth in claim 186, wherein said front-end module applications are comprised of at least a task module software application that enables entity members of said computer-implemented system to have access to task objects.

199. The computer-implemented system for collaboration as set forth in claim 186, wherein said front-end module applications are comprised of at least a contact module software application that enables entity members of said computer-implemented system to have access to contact objects.

200. The computer-implemented system for collaboration as set forth in claim 199, wherein said contact module software application contains contact information for member entities and non-member entities.

201. The computer-implemented system for collaboration as set forth in claim 186, wherein said front-end module applications are comprised of at least an instant messaging module application that enables entity members of said computer-implemented system to have access to instant messaging objects.

202. The computer-implemented system for collaboration as set forth in claim 186, wherein said front-end module applications are comprised of at least an instant messaging module software application, which is instantiated by said entity member of said computer-implemented system to commence an instant messaging session, and where said computer-implemented system saves said instant messaging session into said work zone selected by said entity member.

203. The computer-implemented system for collaboration as set forth in claim 186, wherein said front-end module applications are comprised of at least an instant messaging module application, which is instantiated by said work zone member within the context of a particular work zone to commence an instant messaging session, where said computer implemented system saves said instant messaging session into said particular work zone.

204. The computer-implemented system for collaboration as set forth in claim 186, wherein said front-end module applications are comprised of at least an electronic mail module software application that enables entity members to have access electronic mail objects.

205. The computer-implemented system for collaboration as set forth in claim 182, wherein said work zone includes an electronic mail module software application with at least one work zone aware electronic mail inbox therein, and where incoming electronic mail are directed to said at least one work zone aware inbox.

206. The computer-implemented system for collaboration as set forth in claim 182, wherein said entity members are assigned a personalized electronic mail address.

207. The computer-implemented system for collaboration as set forth in claim 186, wherein said front-end module applications further includes at least an administration module application, wherein entity members are allowed access to functions related to administration of said computer-implemented system.

208. The computer-implemented system for collaboration as set forth in claim 207, wherein said administration module application further includes at least a site manager module application, wherein entity members are allowed access to functions related to site management of an entity member account.

209. The computer-implemented system for collaboration as set forth in claim 182, wherein said computer-implemented system supports an offline version of said set of software application tools that integrate with an operating system of said access unit for allowing entity members of said computer-implemented system to function offline.

210. The computer-implemented system for collaboration as set forth in claim 209, wherein information generated within said set of software application tools while offline, is replicated and synchronized with said computer-implemented system said entity members reconnect to entity member accounts.

211. The computer-implemented system for collaboration as set forth in claim 182, wherein said computer-implemented system provides Internet search functionality integral with said computer-implemented system.

212. The computer-implemented system for collaboration as set forth in claim 211, wherein entity members using said Internet search functionality are provided with results and a sponsored search listing, where upon selection of at least one sponsor from said sponsored search listing said entity members are directed to said selected sponsor advertisement web-site outside said computer-implemented system, and where said computer-implemented system is compensated by said selected sponsor for directing said entity member to said selected sponsor advertisement web-site.

213. The computer-implemented system for collaboration as set forth in claim 211, wherein said Internet search functionality provides both a local and a global search capability.

214. The computer-implemented system for collaboration as set forth in claim 213, wherein said local search capability provides search results with information that are local to a geographic area selected by said entity member.

215. The computer-implemented system for collaboration as set forth in claim 186, wherein said back-end core applications are comprised of a data, access, handler, and manager layers, and cross-layer subsystems that include a security subsystem and a utility subsystem.

216. The computer-implemented system for collaboration as set forth in claim 186, wherein said back-end core applications are comprised of at least a data layer, which is a portion of said back-end core applications that stores data for use by said computer-implemented system.

217. The computer-implemented system for collaboration as set forth in claim 216, wherein said data layer is comprised of a first component for sending, receiving, and storing messages, a second component for storing data, and a third component for storing files.

218. The computer-implemented system for collaboration as set forth in claim 217, wherein said second component is a relational database system for storing data, and said third component is a file storage system for storing data appropriately saved in file storage systems.

219. The computer-implemented system for collaboration as set forth in claim 218, wherein said relational database system is divided into two major sets of foundation and module tables, with said foundation tables including data related to infrastructure of said computer-implemented system and said module tables related to front-end module applications of said computer-implemented system.

220. The computer-implemented system for collaboration as set forth in claim 218, wherein said relational database system includes work zone identification data that relates said computer-implemented system objects to a particular work zone object, thereby making said computer-implemented system objects and any associated objects therewith work zone aware.

221. The computer-implemented system for collaboration as set forth in claim 215, wherein said access layer provides access layer objects for controlling access to said data layer, and base-functionality for use in other layers.

222. The computer-implemented system for collaboration as set forth in claim 215, wherein said access layer is comprised of a first component access for accessing said first component of said data layer, a database access component for accessing said database component of said data layer, a file access component for accessing said file storage component of said data layer, a security access component for accessing a security component of said data layer, and a logging access component for providing a mechanism for reporting errors.

223. The computer-implemented system for collaboration as set forth in claim 222, wherein said database access component of said access layer is comprised of initializer objects for resolving seemingly irresolvable conflicts, and destructor objects for handling processes of removing fundamental objects from said foundation tables of said data layer, and for providing a central method to store logic associated therewith.

224. The computer-implemented system for collaboration as set forth in claim 215, wherein said handler layer is comprised of handler objects that wrap functionality of said access layer objects, with each said handler layer object using said access layer objects to access a different component of said data layer.

225. The computer-implemented system for collaboration as set forth in claim 215, wherein said manager layer is comprised of manager layer objects that provide an interface used by said front-end module applications, and shield the rest of said back-end core applications from improper access.

226. The computer-implemented system for collaboration as set forth in claim 225, wherein all requests for connections to said data layer are generated by said manager layer objects, and passed onto said handler layer objects.

227. The computer-implemented system for collaboration as set forth in claim 215, wherein said security subsystem provides complete control over said entity members and all computer-implemented system objects, and provide both external and internal security to said computer-implemented system.

228. The computer-implemented system for collaboration as set forth in claim 227, wherein said external security controls public interface with said front-end module applications, and is comprised of:
an encryption security module for encrypting all communication between said access unit and said server computer to ensure privacy;
a threat detection module that monitors and detects transmissible threats overall all data transmissions; and
an intrusion detection module that does network monitoring to diminish the impact of intruders.

229. The computer-implemented system for collaboration as set forth in claim 227, wherein said internal security protect the data contained in said back-end core, and is comprised of:
an authentication module for authentication of entity members to access said computer-implemented system; and
a permission management module that facilitates an object-based security system for said computer-implemented system, where each said computer-implemented system object and entity member related to said computer-implemented system has the ability to have defined for said computer-implemented system object and said entity member individual user rights.

230. The computer-implemented system for collaboration as set forth in claim 229, wherein said object-based security system generates security objects, wherein association of said security object with said computer-implemented system objects enables authorized access to said computer-implemented system, and said computer-implemented system objects.

231. The computer-implemented system for collaboration as set forth in claim 229, wherein setting security on said computer-implemented system objects using said security objects automatically makes said computer-implemented system objects available to all entitled entity members of said computer-implemented system.

232. The computer-implemented system for collaboration as set forth in claim 229, wherein said association of said security objects with each computer-implemented system object is comprised of:
a) selecting entity members and groups of entity members to be associated with said computer-implemented system object; and
b) selecting a specific set of permissions for each of said selected entity members and groups of entity members to provide distinct, assign-able access rights to said computer-implemented system object;
whereby said security object enables authorization and a varied level of allowed access rights and privileges to said computer-implemented system object.

233. The computer-implemented system for collaboration as set forth in claim 229, wherein said object-based security system is an inherent part of said computer-implemented system, providing object-based security objects for any computer-implemented system objects.

234. The computer-implemented system for collaboration as set forth in claim 229, wherein every said computer-implemented system object is linked to one security object, and each said security object is linked to one computer-implemented system object.

235. The computer-implemented system for collaboration as set forth in claim 229, wherein a plurality of computer implemented system objects are linked to one said security object, sharing analogous authorizations.

236. The computer-implemented system for collaboration as set forth in claim 229, wherein each security object enables an entity member to define access rights for each computer-implemented system object.

237. The computer-implemented system for collaboration as set forth in claim 182, wherein said computer-implemented system is one of a Web, Internet, Intranet, and Extranet based systems.

238. The computer-implemented system for collaboration as set forth in claim 237, wherein said computer-implemented system enables an authorized entity member instant access to up-to-date project related information without a need for synchronization.

239. The computer-implemented system for collaboration as set forth in claim 182, wherein access to said computer-implemented system is through a single login into an account of said entity member.

240. The computer-implemented system for collaboration as set forth in claim 239, wherein said account set up for said computer-implemented system is comprised of:
collecting information about an entity;
selecting a vertical set of software application for said account by said entity;
collection of billing data, and verification of said collected data; and
redirection of said entity to access said account though said single login.

241. The computer-implemented system for collaboration as set forth in claim 182, wherein said computer-implemented system is comprised of at least one server computer, within which said set of software application tools reside.

242. The computer-implemented system for collaboration as set forth in claim 241, wherein said at least one server computer is accessed by said access unit through at least one of a secured and an unsecured communications protocols.

243. A method for providing security for accessing computer-implemented system objects, comprising the act of:
providing a permission management module that facilitates an object-based security system for said computer-implemented system objects, where each said computer-implemented system object has the ability to have defined for said computer-implemented system object individual user rights.

244. The method for providing security for accessing computer-implemented system objects as set forth in claim 243, wherein said object-based security system generates security objects, wherein association of said security object with said computer-implemented system objects enables authorized access to said computer-implemented system, and said computer-implemented system objects.

245. The method for providing security for accessing computer-implemented system objects as-set forth in claim 244, wherein setting security on said computer-implemented system objects using said security objects automatically makes said computer-implemented system objects available to all entitled users of said computer-implemented system.

246. The method for providing security for accessing computer-implemented system objects as set forth in claim 244, wherein said association of said security objects with each computer-implemented system object is comprised of:
a) selecting users and groups of users to be associated with said computer-implemented system object; and
b) selecting a specific set of permissions for each of said selected users and groups of users to provide distinct, assign-able access rights to said computer-implemented system object;
whereby said security object enables authorization and a varied level of allowed access rights and privileges to said computer-implemented system object.

247. The method for providing security for accessing computer-implemented system objects as set forth in claim 243, wherein said object-based security system is an inherent part of said computer-implemented system, providing object-based security objects for any computer-implemented system objects.

248. The method for providing security for accessing computer-implemented system objects as set forth in claim 243, wherein every said computer-implemented system object is linked to one security object, and each said security object is linked to one computer-implemented system object.

249. The method for providing security for accessing computer-implemented system objects as set forth in claim 243, wherein a plurality of computer implemented system objects are linked to one said security object, sharing analogous authorizations.

250. The method for providing security for accessing computer-implemented system objects as set forth in claim 243, wherein each security object enables an entity member to define access rights for each computer-implemented system object.

251. A method for providing discussions for a computer-implemented system, comprising the acts of:
providing a discussion module software application that is comprised of an object-based discussion manager, which generates discussion objects that are associated with computer-implemented system objects to enable discussion forums about said computer-implemented system objects.

252. The method for collaboration as set forth in claim 251, wherein said object-based discussion manager is an inherent part of said computer-implemented system, providing an object-based threaded discussion forum functionality for any computer-implemented system object.
